(19) United States
(12) Patent Application Publication
(10) Pub. No.: US 2013/0185064 A1
(43) Pub. Date: Jul. 18, 2013

(54) ECHO REMOVING APPARATUS, ECHO REMOVING METHOD, PROGRAM AND RECORDING MEDIUM

(71) Applicant: Mitsuhiro SUZUKI, Tokyo (JP)

(72) Inventor: Mitsuhiro SUZUKI, Tokyo (JP)

(73) Assignee: Sony Corporation, Tokyo (JP)

(21) Appl. No.: 13/554,523

(22) Filed: Jul. 20, 2012

(30) Foreign Application Priority Data
Jul. 27, 2011 (JP) 2011-163936

(51) Int. Cl. G10L 21/0216

(52) U.S. Cl. CPC G10L 21/0216
USPC 704/226

(57) ABSTRACT

To be provided is an echo removing apparatus including a transmission path estimate update processing unit, and an output selection unit. A fixed section of the transmission path estimate is updated based on an error from an echo estimate determined using all of the fixed section, the holding section, and the update section. These sections are updated depending on whether an estimate obtained by adding the fixed section and the holding section is better than an estimate of the fixed section alone in every fixed period. Only when the estimate is better, the holding section is added to the fixed section cumulatively, and the update section is substituted into the holding section. Depending on whether an estimate is better, an error from the eco estimate determined using all these sections or the fixed section alone is selected as an output.

### BACKGROUND

The present technology relates to an echo removing apparatus, an echo removing method, a program, and a recording medium, and in particular, relates to an echo removing apparatus capable of removing an echo satisfactorily even if a disturbance such as double talks is caused.

In a system communicating a collected signal through a microphone bidirectionally such as a telephone system and videoconference system, degradation in call quality due to an occurrence of echo has been known. For example, if a voice signal collected at a far end (remote side) is output through a speaker at a near end (local side) and the reproduced voice is circulated around a microphone and collected at the near end, the voice signal is returned to the far end as an echo. Also, for example, if a voice signal collected at the near end is output through a speaker at the far end and the reproduced voice is circulated around a microphone and collected at the far end, the voice signal is returned to the near end as an echo.

FIG. 15 schematically shows the principle of generation of an echo. In FIG. 15, the path of a broken line is a path of echo generation by a voice signal yf collected at the far end. That is, the voice signal yf obtained after a voice Vf being collected through the microphone at the far end is supplied to the speaker at the near end for reproduction. The reproduced voice is circulated around the microphone at the near end and collected after going through acoustic absorption characteristics hn of the microphone from the speaker. Then, a voice signal yn by the voice collection is returned to the speaker at the far end as an echo for reproduction.

Similarly, in FIG. 15, the path of a constant chain line is a path of echo generation by the voice signal yn collected at the near end. That is, the voice signal yn obtained after a voice Vn being collected through the microphone at the near end is supplied to the speaker at the far end for reproduction. The reproduced voice is circulated around the microphone at the far end and collected after going through acoustic absorption characteristics hf of the microphone from the speaker. Then, the voice signal yf by the voice collection is returned to the speaker at the near end as an echo for reproduction.

Echo components have been canceled (subtracted) by estimating circulating acoustic absorption characteristics at the far end and the near end. FIG. 16 schematically shows the principle of cancellation of echoes. At the near end, an echo estimate is determined from a voice signal transmitted from the far end based on a transfer characteristic estimation vector [hn (hat)]. Then, the echo estimate is subtracted from the voice signal yn obtained by being collected through a microphone and a voice signal with an echo component removed is transmitted to the far end.

At the far end, on the other hand, an echo estimate is determined from a voice signal transmitted from the near end based on a transfer characteristic estimation vector [hf (hat)]. Then, the echo estimate is subtracted from the voice signal yf obtained by being collected through a microphone and a voice signal with an echo component removed is transmitted to the near end.

The transfer characteristic estimation vector is updated by an adaptive algorithm, typically LMS (Least Mean Square). FIG. 17 shows a configuration example of an echo removing apparatus (echo canceller) 200 configured to update the transfer characteristic estimation vector by using the LMS algorithm. In the description that follows, the echo removing apparatus 200 is assumed to be arranged at the near end.

The echo removing apparatus 200 includes a buffer unit 201, a register unit 202, a subtractor 203, a multiplier 204, a coefficient unit 205, and an adder 206. In FIG. 17, a speaker SP reproduces an input voice signal xk transmitted from the far end to output a reproduced voice. Also in FIG. 17, a microphone MC collects a voice nk at the near end. A reproduced voice from the speaker SP is circulated around the microphone MC and collected after going through acoustic absorption characteristics h.

The buffer unit 201 temporarily accumulates the input voice signal xk to output the input voice signal vector xk=(xk−N−1, . . . , xk−2, xk−1, xk) vectorized with a sample size N that can cover the length of an echo. xk indicates the current sample. If, for example, the sampling frequency of the input voice signal xk is 8 kHz and the length of echo is 10 msec, the sample size N is “80”.

The register unit 202 stores a transfer characteristic estimation vector h (hat) of order N. The register unit 202 also calculates an inner product of the input voice signal vector xk=(xk−N−1, . . . , xk−2, xk−1, xk) output from the buffer unit 201 and the transfer characteristic estimation vector [h (hat)] of order N to determine an echo estimate yk (hat). Calculating an inner product corresponds to performing a convolution operation and the echo estimate yk (hat) can be determined by the following formula (1):

$${\hat{y}}_{k} = {\sum }_{i = 0}^{N - 1} {\hat{h}}_{i} {x}_{k - i} \qquad ( 1 )$$

The subtractor 203 subtracts the echo estimate yk (hat) determined by the register unit 202 from the voice signal yk collected and obtained by the microphone MC to determine an error signal ek. The error signal ek is transmitted to the far end as an output voice signal nk (hat) whose echo component is canceled.

The multiplier 204 multiplies the input voice signal vector xk=(xk−N−1, . . . , xk−2, xk−1, xk) output from the buffer unit 201 by the error signal ek determined by the subtractor 203. The coefficient unit 205 multiplies the output of the multiplier 204 by the appropriate weight μ (for example, 0.01 or the like). The adder 206 cumulatively adds the output (N-dimensional vector) of the coefficient unit 205 to the transfer characteristic estimation vector h (hat) of order N stored in the register unit 202. The register unit 202 stores the cumulatively added value as a new transfer characteristic estimation vector h (hat) of order N to update storage content.

The operation of the echo removing apparatus 200 shown in FIG. 17 will be described. The input voice signal xk transmitted from the far end is supplied to the buffer unit 201. In the buffer unit 201, the input voice signal xk is temporarily accumulated to obtain the input voice signal vector xk=(xk−N−1, . . . , xk−2, xk−1, xk) vectorized with the sample size N that can cover the length of an echo. The input voice signal vector xk is supplied to the register unit 202 and the multiplier 204.

The register unit 202 has the transfer characteristic estimation vector h (hat) of order N stored therein. Then, the register unit 202 calculates an inner product of the input voice signal vector xk=(xk−N−1, . . . , xk−2, xk−1, xk) of order N from the buffer unit 201 and the transfer characteristic estimation vector h (hat) of order N to determine the echo estimate yk (hat) (see the formula (1)). The echo estimate yk (hat) is supplied to the subtractor 203.

The subtractor 203 subtracts the echo estimate yk (hat) from the voice signal yk collected and obtained by the microphone MC to determine the error signal ek. The error signal ek is transmitted to the far end as the output voice signal nk (hat) whose echo component is canceled. The error signal ek is supplied to the multiplier 204.

The multiplier 204 multiplies the input voice signal vector xk=(xk−N−1, . . . , xk−2, xk−1, xk) by the error signal ek. The output from the multiplier 204 is supplied to the adder 206 after being multiplied by the appropriate weight μ by the coefficient unit 205. The adder 206 cumulatively adds the output (N-dimensional vector) of the coefficient unit 205 to the transfer characteristic estimation vector h (hat) of order N stored in the register unit 202. Then, the register unit 202 stores the cumulatively added value as a new transfer characteristic estimation vector h (hat) of order N to update the transfer characteristic estimation vector h (hat).

In the echo removing apparatus 200 shown in FIG. 17, because a voice from the far end is used as a reference signal, the transfer characteristic estimation vector h (hat) stored in the register unit 202 is estimated when the voice is not silent. Normally, people speak alternately in a conversation, but if a voice nk at the near end is pronounced simultaneously with a voice at the far end, the voice nk at the near end becomes a disturbance regarding transfer characteristic estimation, disturbing the transfer characteristic estimate. Accordingly, an echo may not adequately be canceled or voice transmitted to the far end may be distorted. For example, Japanese Patent Application Laid-Open No. 2006-270709 describes that detection of an occurrence of disturbance is dealt with by stopping updating an adaptive algorithm in the applicable section.

### SUMMARY

According to the method described in Japanese Patent Application Laid-Open No. 2006-270709, (1) it is difficult to detect an occurrence of disturbance with precision and (2) when an occurrence of disturbance is detected, an adaptive algorithm has been updated, presenting a difficulty that a transfer characteristic estimation vector has been disturbed, which makes it difficult to improve performance of an echo removing apparatus.

Thus, it is desirable to improve performance of an echo removing apparatus.

A concept of the present technology is an echo removing apparatus including a transmission path estimate update processing unit and an output selection unit, wherein the transmission path estimate update processing unit divides a transmission path estimate into a fixed section, a holding section, and an update section, updates the update section of the transmission path estimate with an error from an echo estimate determined by using all of the fixed section, the holding section, and the update section of the transmission path estimate, adds the holding section of the transmission path estimate to the fixed section of the transmission path estimate cumulatively and substitutes the update section of the transmission path estimate into the holding section of the transmission path estimate before clearing the update section to zero if it is determined that an estimate obtained by adding the fixed section and the holding section of the transmission path estimate is better than an estimate of the fixed section alone of the transmission path estimate in every fixed period, substitutes the update section of the transmission path estimate into the holding section of the transmission path estimate before clearing the update section to zero if it is determined that the estimate obtained by adding the fixed section and the holding section of the transmission path estimate is not better than the estimate of the fixed section alone of the transmission path estimate in the every fixed period and the output selection unit selects the error from the echo estimate determined by using all of the fixed section, the holding section, and the update section of the transmission path estimate as an output voice signal if it is determined that the estimate obtained by adding the fixed section and the holding section of the transmission path estimate is better than the estimate of the fixed section alone of the transmission path estimate in the every fixed period and selects the error from the echo estimate determined by using the fixed section alone of the transmission path estimate as the output voice signal if it is determined that the estimate obtained by adding the fixed section and the holding section of the transmission path estimate is not better than the estimate of the fixed section alone of the transmission path estimate in the every fixed period.

The present technology includes a transmission path estimate update processing unit and an output selection unit. The transmission path estimate update processing unit divides a transmission path estimate into a fixed section, a holding section, and an update section. Then, the transmission path estimate update processing unit updates the update section of the transmission path estimate with an error from an echo estimate determined by using all of the fixed section, the holding section, and the update section of the transmission path estimate.

Also, the transmission path estimate update processing unit updates the fixed section, the holding section, and the update section of the transmission path estimate depending on whether it is determined that an estimate obtained by adding the fixed section and the holding section of the transmission path estimate is better than an estimate of the fixed section alone of the transmission path estimate in every fixed period as follows. That is, if the estimate obtained by adding the fixed section and the holding section of the transmission path estimate is determined to be better, the holding section is cumulatively added to the fixed section and the update section is substituted into the holding section before the update section being cleared to zero. On the other hand, if the estimate obtained by adding the fixed section and the holding section of the transmission path estimate is not determined to be better, the update section is substituted into the holding section before the update section being cleared to zero. In this case, the holding section is not cumulatively added to the fixed section.

The output selection unit selects an output voice signal depending on whether it is determined that the estimate obtained by adding the fixed section and the holding section of the transmission path estimate is better than the estimate of the fixed section alone of the transmission path estimate in every fixed period as follows. That is, if the estimate obtained by adding the fixed section and the holding section of the transmission path estimate is determined to be better, the error from the echo estimate determined by using all of the fixed section, the holding section, and the update section of the transmission path estimate is selected as an output voice signal. On the other hand, if the estimate obtained by adding the fixed section and the holding section of the transmission path estimate is not determined to be better, the error from the echo estimate determined by using the fixed section alone of the transmission path estimate is selected as the output voice signal.

Thus, according to the present technology, the update section of the transmission path estimate is substituted into the holding section of the transmission path estimate in every fixed period, but if the estimate obtained by adding the fixed section and the holding section of the transmission path estimate is not determined to be better than the estimate of the fixed section alone of the transmission path estimate, the holding section of the transmission path estimate is not cumulatively added to the fixed section of the transmission path estimate. Thus, the fixed section of the transmission path estimate is not disturbed even if there is a disturbance and thus is resistant to disturbance.

Also according to the present technology, if the estimate obtained by adding the fixed section and the holding section of the transmission path estimate is not determined to be better than the estimate of the fixed section alone of the transmission path estimate, the error from the echo estimate determined by using the fixed section alone of the transmission path estimate is selected as the output voice signal. Thus, a stable output voice signal whose echo component is canceled can be obtained.

Also according to the present technology, the update section of the transmission path estimate is updated with the error from the echo estimate determined by using all of the fixed section, the holding section, and the update section of the transmission path estimate. Thus, the transmission path estimation of the fixed section, the holding section, and the update section of the transmission path estimate as a whole remains the same and convergence characteristics are not degraded.

According to the present technology, for example, the transmission path estimate update processing unit may set the update section as a first update section and further prepare a second update section separately from the first update section, update the second update section of the transmission path estimate with the error from the echo estimate determined by using the fixed section and the second update section of the transmission path estimate, add the holding section of the transmission path estimate to the fixed section of the transmission path estimate cumulatively and substitute the first update section of the transmission path estimate into the holding section of the transmission path estimate before clearing the first update section and the second update section to zero if it is determined that the estimate obtained by adding the fixed section and the holding section of the transmission path estimate is better than the estimate of the fixed section alone of the transmission path estimate in every fixed period, substitute the second update section of the transmission path estimate into the holding section of the transmission path estimate before clearing the second update section and the first update section to zero if it is determined that the estimate obtained by adding the fixed section and the holding section of the transmission path estimate is not better than the estimate of the fixed section alone of the transmission path estimate in the every fixed period.

In this case, if the estimate obtained by adding the fixed section and the holding section of the transmission path estimate is not determined to be better than the estimate of the fixed section alone of the transmission path estimate in every fixed period, the second update section is substituted into the holding section. The second update section is updated with the error from the echo estimate determined by using the fixed section and the second update section of the transmission path estimate. Thus, an update operation that is not affected by the holding section whose transmission path estimate is disturbed by a disturbance can be performed and therefore, transmission path estimation with precision can be continued immediately after the disturbance.

Also, according to the present technology, for example, a determination unit that determines whether the estimate obtained by adding the fixed section and the holding section of the transmission path estimate is better than the estimate of the fixed section alone of the transmission path estimate based on the error of the echo estimate determined by using the fixed section and the holding section of the transmission path estimate and the error of the echo estimate determined by using the fixed section alone of the transmission path estimate in every fixed period may further be included.

Also, according to the present technology, for example, the transmission path estimate update processing unit may include a transmission path estimate storage unit that stores the fixed section, the holding section, and the update section of the transmission path estimate, an echo estimate acquisition unit that acquires a first echo estimate by using an input voice signal and the fixed section of the transmission path estimate and also acquires a third echo estimate by using the input voice signal and all of the fixed section, the holding section, and the update section of the transmission path estimate, an error signal acquisition unit that acquires a first error signal by subtracting the first echo estimate from a collected signal and also acquires a third error signal by subtracting the third echo estimate from the collected signal, a first transmission path estimate update unit that updates the update section of the transmission path estimate based on the third error signal, and a second transmission path estimate update unit that cumulatively adds the holding section of the transmission path estimate to the fixed section of the transmission path estimate and substitutes the update section of the transmission path estimate into the holding section of the transmission path estimate before clearing the update section to zero if the estimate obtained by adding the fixed section and the holding section of the transmission path estimate is better than the estimate of the fixed section alone of the transmission path estimate and substitutes the update section of the transmission path estimate into the holding section of the transmission path estimate before clearing the update section to zero if the estimate obtained by adding the fixed section and the holding section of the transmission path estimate is not better than the estimate of the fixed section alone of the transmission path estimate, wherein the output selection unit may select the third error signal as the output voice signal if the estimate obtained by adding the fixed section and the holding section of the transmission path estimate is better than the estimate of the fixed section alone of the transmission path estimate and select the first error signal as the output voice signal if the estimate obtained by adding the fixed section and the holding section of the transmission path estimate is not better than the estimate of the fixed section alone of the transmission path estimate.

According to the present technology, a transmission path estimate is divided into three portions of the fixed section, the holding section, and the update section and each section is stored in the transmission path estimate storage unit. The first echo estimate and the third echo estimate are acquired by the echo estimate acquisition unit. The first echo estimate is acquired by using an input voice signal and the fixed section of the transmission path estimate. The third echo estimate is acquired by using an input voice signal and all of the fixed section, the holing section, and the update section of the transmission path estimate.

The first error signal and the third error signal are acquired by the error signal acquisition unit. The first error signal is acquired by subtracting the first echo estimate from the collected signal. The third error signal is acquired by subtracting the third echo estimate from the collected signal. The update section of the transmission path estimate is updated by the first transmission path estimate update unit based on the third error signal. An adaptive algorithm such as LMS is used for the update. The transmission path estimate is updated by the second transmission path estimate update unit in every fixed period based on a determination result whether the estimate obtained by adding the fixed section and the holding section of the transmission path estimate is better than the estimate of the fixed section alone of the transmission path estimate.

For example, the echo estimate acquisition unit may further acquire a second echo estimate by using the input voice signal and the fixed section and the holding section of the transmission path estimate, the error signal acquisition unit may further acquire a second error signal by subtracting the second echo estimate from the collected signal, further include an energy acquisition unit that acquires energy EN1 of the collected signal, energy EN2 of the first error signal, energy EN3 of the second error signal, and energy EN4 of the third error signal of the fixed period immediately before in every fixed period, and further include a determination unit that determines that the estimate obtained by adding the fixed section and the holding section of the transmission path estimate is better than the estimate of the fixed section alone of the transmission path estimate in the fixed period immediately before if EN2/EN3>1.0, or EN (EN4, EN2, or EN3)/EN1<<1.0 and EN2/EN3>˜1.0.

If the estimate obtained by adding the fixed section and the holding section is determined to be better by the second transmission path estimate update unit, the holding section of the transmission path estimate is cumulatively added to the fixed section of the transmission path estimate and the update section of the transmission path estimate is substituted as the holding section of the transmission path estimate before the update section being cleared to zero. On the other hand, if the estimate obtained by adding the fixed section and the holding section of the transmission path estimate is not determined to be better, the update section of the transmission path estimate is substituted into the holding section of the transmission path estimate before the update section being cleared to zero.

Then, the output voice signal to be output as a voice signal whose echo component is canceled is selected by the output selection unit in every fixed period based on the determination result. In this case, if determined to be better, the third error signal is selected as the output voice signal. On the other hand, if not determined to be better, the first error signal is selected as the output voice signal.

Thus, according to the present technology, the update section of the transmission path estimate is substituted into the holding section of the transmission path estimate in every fixed period, but if the fixed period immediately before is determined to be a disturbance period, the holding section of the transmission path estimate is not cumulatively added to the fixed section of the transmission path estimate. Thus, the fixed section of the transmission path estimate is not disturbed even if there is a disturbance and thus is resistant to disturbance.

Also according to the present technology, if the fixed period immediately before is determined to be a disturbance period, the first error signal is selected as the output voice signal. The first error signal is obtained by subtracting the first echo estimate determined by the fixed section alone of a transmission path estimate from a collected signal and a stable signal as the output voice signal whose echo component is canceled can be obtained.

Also according to the present technology, the third echo estimate is obtained by using the input voice signal and all of the fixed section, the holding section, and the update section of the transmission path estimate and the third error signal is obtained by subtracting the third echo estimate from the collected signal. Then, the update section of the transmission path estimate is updated based on the third error signal. Thus, the transmission path estimation of the fixed section, the holding section, and the update section of the transmission path estimate as a whole remains the same and convergence characteristics are not degraded.

Incidentally, according to the present technology, for example, the transmission path estimate storage unit may set the update section as a first update section and further store a second update section separately from the first update section, the echo estimate acquisition unit may acquire a fourth echo estimate by using the input voice signal and the fixed section and the second update section of the transmission path estimate, the error signal acquisition unit may acquire a fourth error signal by subtracting the fourth echo estimate from the collected signal and further include a third transmission path estimate update unit that updates the second update section of the transmission path estimate based on the fourth error signal, and the second transmission path estimate update unit may cumulatively add the holding section of the transmission path estimate to the fixed section of the transmission path estimate and substitute the first update section of the transmission path estimate into the holding section of the transmission path estimate before clearing the first update section and the second update section to zero if the estimate obtained by adding the fixed section and the holding section of the transmission path estimate is better than the estimate of the fixed section alone of the transmission path estimate and substitute the second update section of the transmission path estimate into the holding section of the transmission path estimate before clearing the second update section and the first update section to zero if the estimate obtained by adding the fixed section and the holding section of the transmission path estimate is not better than the estimate of the fixed section alone of the transmission path estimate.

In this case, if the estimate obtained by adding the fixed section and the holding section of the transmission path estimate is determined to be better than the estimate of the fixed section alone of the transmission path estimate, the second update section of the transmission path estimate is substituted into the holding section of the transmission path estimate. The second update section is updated based on the fourth error signal obtained by subtracting the fourth echo estimate obtained by using the input voice signal and the fixed section and the second update section of the transmission path estimate from the collected signal. Thus, an update operation that is not affected by the holding section whose transmission path estimate is disturbed by a disturbance can be performed and therefore, transmission path estimation with precision can be continued immediately after the disturbance.

According to the present technology, performance of an echo removing apparatus can be improved.

### BRIEF DESCRIPTION OF THE DRAWINGS

FIG. 1 is a block diagram showing a configuration example of an echo removing apparatus according to a first embodiment of the present technology;

FIG. 2 is a block diagram showing a configuration example of an evaluation unit constituting the echo removing apparatus;

FIG. 3 is a diagram showing a transition example of a fixed section hfix (hat), a holding section hsusp (hat), and an update section hadapt (hat) of a transfer characteristic estimation vector, energy of first, second, and third error signals e(1)k, e(2)k, e(3)k, control signals CN1, CN2, and an output selection;

FIG. 4 is a flow chart (1/2) showing an example of a processing procedure for echo removal for the echo removing apparatus;

FIG. 5 is a flow chart (2/2) showing the example of the processing procedure for echo removal for the echo removing apparatus;

FIG. 6 is a flow chart showing details of processing to determine first to third echo estimates;

FIG. 7 is a flow chart showing details of processing to determine first to third error signals;

FIG. 8 is a flow chart showing details of processing to determine whether a fixed period immediately before is a disturbance period;

FIG. 9 is a block diagram showing a configuration example of an echo removing apparatus according to a second embodiment of the present technology;

FIG. 10 is a diagram showing a transition example of the fixed section hfix (hat), the holding section hsusp (hat), the update section hadapt (hat), and an update section hspare (hat) of the transfer characteristic estimation vector, energy of the first, second, and third error signals e(1)k, e(2)k, e(3)k, the control signals CN1, CN2, and the output selection;

FIG. 11 is a flow chart (1/2) showing an example of the processing procedure for echo removal for the echo removing apparatus;

FIG. 12 is a flow chart (2/2) showing the example of the processing procedure for echo removal for the echo removing apparatus;

FIG. 13 is a flow chart showing details of processing to determine first to fourth echo estimates;

FIG. 14 is a flow chart showing details of processing to determine first to fourth error signals;

FIG. 15 is a diagram schematically showing the principle of generation of an echo;

FIG. 16 is a diagram schematically showing the principle of cancellation of echoes; and

FIG. 17 is a block diagram showing a configuration example of an echo removing apparatus (echo canceller) configured to update the transfer characteristic estimation vector by using the LMS algorithm.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Forms (hereinafter, referred to as embodiments) to embody the present technology will be described below. The description will be provided in the order shown below:

1. First embodiment

2. Second embodiment

3. Modification

### 1. First Embodiment

### Configuration Example of the Echo Removing Apparatus

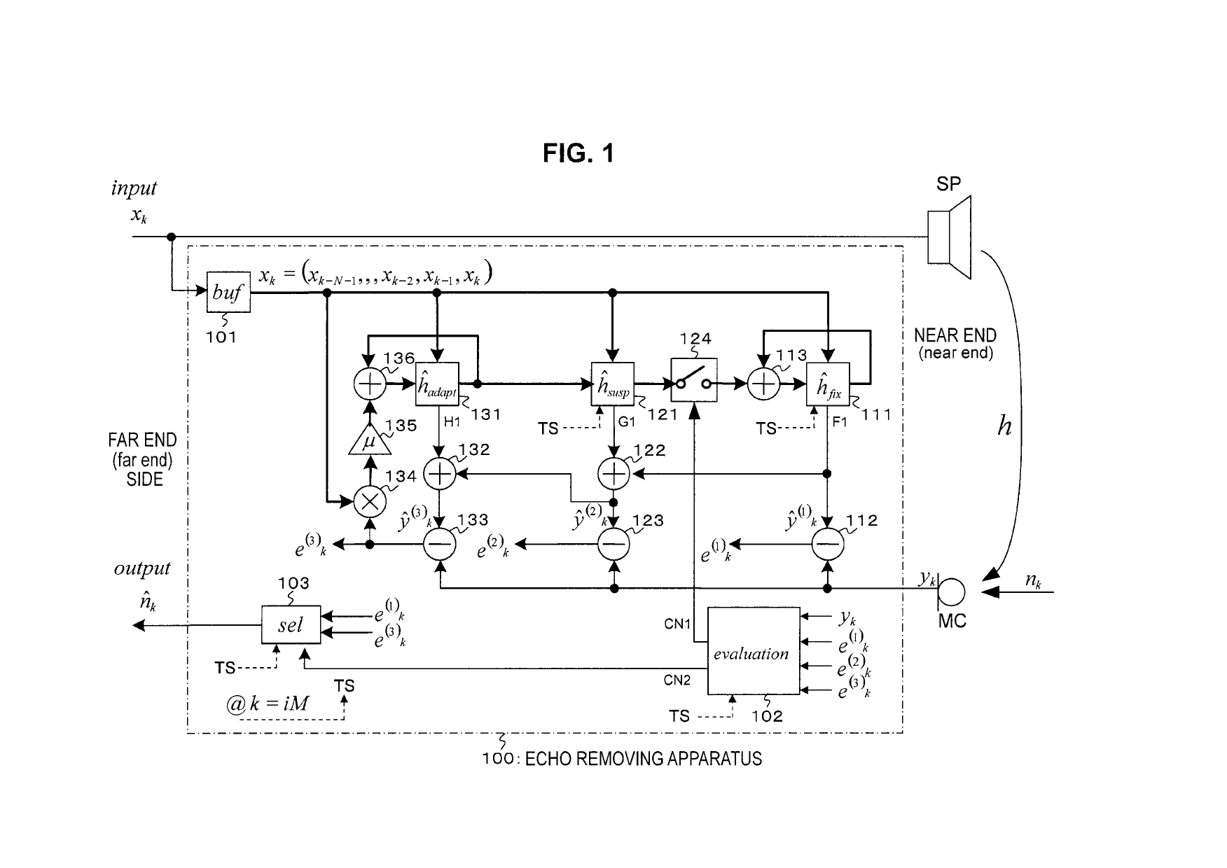

FIG. 1 shows a configuration example of an echo removing apparatus (echo canceller) 100 according to the first embodiment. The echo removing apparatus 100 is configured to update a transfer characteristic estimation vector by using the LMS algorithm. In the description that follows, the echo removing apparatus 100 is assumed to be arranged at the near end.

The echo removing apparatus 100 includes a buffer unit 101, an evaluation unit 102, and an output selection unit 103. The echo removing apparatus 100 also includes a register unit 111, a subtractor 112, and an adder 113. The echo removing apparatus 100 also includes a register unit 121, an adder 122, a subtractor 123, and a connection switch 124. Further, the echo removing apparatus 100 also includes a register unit 131, an adder 132, a subtractor 133, a multiplier 134, a coefficient unit 135, and an adder 136.

The register units 111, 121, 131 constitute a transmission path estimate storage unit. The register units 111, 121, 131 and the adders 122, 132 constitute an echo estimate acquisition unit. The subtractors 112, 123, 133 constitute an error signal acquisition unit. The evaluation unit 102 constitutes a disturbance determination unit. The multiplier 134, the multiplier 135, the adder 136, and the register unit 131 constitute a first transmission path estimate update unit. Further, the evaluation unit 102, the connection switch 124, and the register units 111, 121, 131 constitute a second transmission path estimate update unit.

In FIG. 1, the speaker SP reproduces an input voice signal xk transmitted from the far end to output a reproduced voice. Also in FIG. 1, the microphone MC collects a voice nk at the near end. A reproduced voice from the speaker SP is circulated around the microphone MC and collected after going through acoustic absorption characteristics h.

The buffer unit 101 temporarily accumulates the input voice signal xk to output the input voice signal vector xk=(xk−N−1, . . . , xk−2, xk−1, xk) vectorized with a sample size N that can cover the length of an echo. xk indicates the current sample. If, for example, the sampling frequency of the input voice signal xk is 8 kHz and the length of echo is 10 msec, the sample size N is “80”.

The register unit 111 stores the fixed section hfix (hat) of a transfer characteristic estimation vector (transmission path estimate) of order N. The register unit 111 also calculates an inner product of the input voice signal vector xk=(xk−N−1, . . . , xk−2, xk−1, xk) output from the buffer unit 101 and the fixed section hfix (hat) of the transfer characteristic estimation vector of order N. Calculating an inner product corresponds to performing a convolution operation. An inner product value F1 determined by the register unit 111 directly becomes a first echo estimate y(1)k (hat).

The subtractor 112 subtracts the first echo estimate y(1)k (hat) determined by the register unit 111 from the voice signal yk collected and obtained by the microphone MC, that is, a collected signal yk to determine a first error signal e(1)k. When the holding section hsusp (hat) of the transfer characteristic estimation vector of order N is supplied from the register unit 121 through the connection switch 124, the adder 113 cumulatively adds the holding section hsusp (hat) to the fixed section hfix (hat) stored in the register unit 111.

The register unit 111 stores the output of the adder 113 as the fixed section hfix (hat) of a new transfer characteristic estimation vector of order N in every fixed period based on a timing signal TS to update storage content. The fixed period is, for example, a period of every sample size M. When, for example, the fixed period is 1 sec, M=“8000” if the sampling frequency of the input voice signal xk is 8 kHz.

The register unit 121 stores the holding section hsusp (hat) of the transfer characteristic estimation vector of order N. The register unit 121 also calculates an inner product of the input voice signal vector xk=(xk−N−1, . . . , xk−2, xk−1, xk) output from the buffer unit 101 and the holding section hsusp (hat) of the transfer characteristic estimation vector of order N. Calculating an inner product corresponds to performing a convolution operation.

The register unit 121 stores the update section hadapt (hat) of the transfer characteristic estimation vector of order N stored in the register unit 131 in every fixed period based on the timing signal TS as the holding section hsusp (hat). That is, the update section hadapt (hat) is substituted into the holding section hsusp (hat) in every fixed period. After the holding section hsusp (hat) is updated by the substitution, the update section hadapt (hat) is cleared to zero.

The adder 122 adds the inner product value F1 determined by the register unit 111 and an inner product value G1 determined by the register unit 121 to determine a second echo estimate y(2)k (hat). The subtractor 123 subtracts the second echo estimate y(2)k (hat) determined by the adder 122 from the collected signal yk to determine a second error signal e(2)k.

The connection switch 124 selectively supplies the holding section hsusp (hat) of the transfer characteristic estimation vector of order N stored in the register unit 121 to the adder 113. The connection switch 124 is set to a connected state or non-connected state based on the control signal CN1 obtained by the evaluation unit 102. That is, if the evaluation unit 102 determines that the fixed period immediately before is not a disturbance period, the connection switch 124 is set to a connected state and conversely if the evaluation unit 102 determines that the fixed period immediately before is a disturbance period, the connection switch 124 is set to a non-connected state.

The register unit 131 stores the update section hadapt (hat) of the transfer characteristic estimation vector of order N. The register unit 131 also calculates an inner product of the input voice signal vector xk=(xk−N−1, . . . , xk−2, xk−1, xk) output from the buffer unit 101 and the update section hadapt (hat) of the transfer characteristic estimation vector of order N.

The adder 132 adds an inner product value H1 determined by the register unit 131 and the second echo estimate y(2)k (hat) determined by the adder 122 to determine a third echo estimate y(3)k (hat). The subtractor 133 subtracts the third echo estimate y(3)k (hat) determined by the adder 132 from the collected signal yk to determine a third error signal e(3)k.

The multiplier 134 multiplies the input voice signal vector xk=(xk−N−1, . . . , xk−2, xk−1, xk) output from the buffer unit 101 by the third error signal e(3)k determined by the subtractor 133. The coefficient unit 135 multiplies the output of the multiplier 134 by the appropriate weight μ (for example, 0.01 or the like). The adder 136 cumulatively adds the output (N-dimensional vector) of the coefficient unit 135 to the update section hadapt (hat) of the transfer characteristic estimation vector of order N stored in the register unit 131. The register unit 131 stores the cumulatively added value as the update section hadapt (hat) of a new transfer characteristic estimation vector of order N to update storage content.

The output selection unit 103 selectively outputs the first error signal e(1)k determined by the subtractor 112 or the third error signal e(3)k determined by the subtractor 133 as an output voice signal nk (hat). The output selection unit 103 is set to a selected state of the first error signal e(1)k or a selected state of the third error signal e(3)k based on the control signal CN2 obtained by the evaluation unit 102.

That is, if the evaluation unit 102 determines that the fixed period immediately before is not a disturbance period, the output selection unit 103 is set to a selected state of the third error signal e(3)k. If the evaluation unit 102 determines that the fixed period immediately before is a disturbance period, the output selection unit 103 is set to a selected state of the first error signal e(1)k. If there is no disturbance such as a double talk, the third error signal e(3)k has high precision of echo cancellation. The first error signal e(1)k cancels echoes with stability even if there is a disturbance.

The evaluation unit 102 determines whether the estimate obtained by adding the fixed section hfix (hat) and the holding section hsusp (hat) of the transfer characteristic estimation vector is better than the fixed section hfix (hat) of the transfer characteristic estimation vector alone in every fixed period. In the present embodiment, as will be described in detail below, the evaluation unit 102 determines whether the fixed period immediately before is a disturbance period in every fixed period.

The determination of a non-disturbance period corresponds to a determination that the estimate obtained by adding the fixed section hfix (hat) and the holding section hsusp (hat) is better than the fixed section hfix (hat) alone. On the other hand, the determination of a disturbance period corresponds to a determination that the estimate obtained by adding the fixed section hfix (hat) and the holding section hsusp (hat) is better than the fixed section hfix (hat) alone.

The evaluation unit 102 outputs the control signals CN1, CN2 in accordance with the determination result. The control signal CN1 controls, as described above, the connection switch 124 to a connected state or non-connected state. The control signal CN2 controls, as described above, the output selection unit 103 to a selected state of the first error signal e(1)k or a selected state of the third error signal e(3)k.

### Configuration Example of the Evaluation Unit

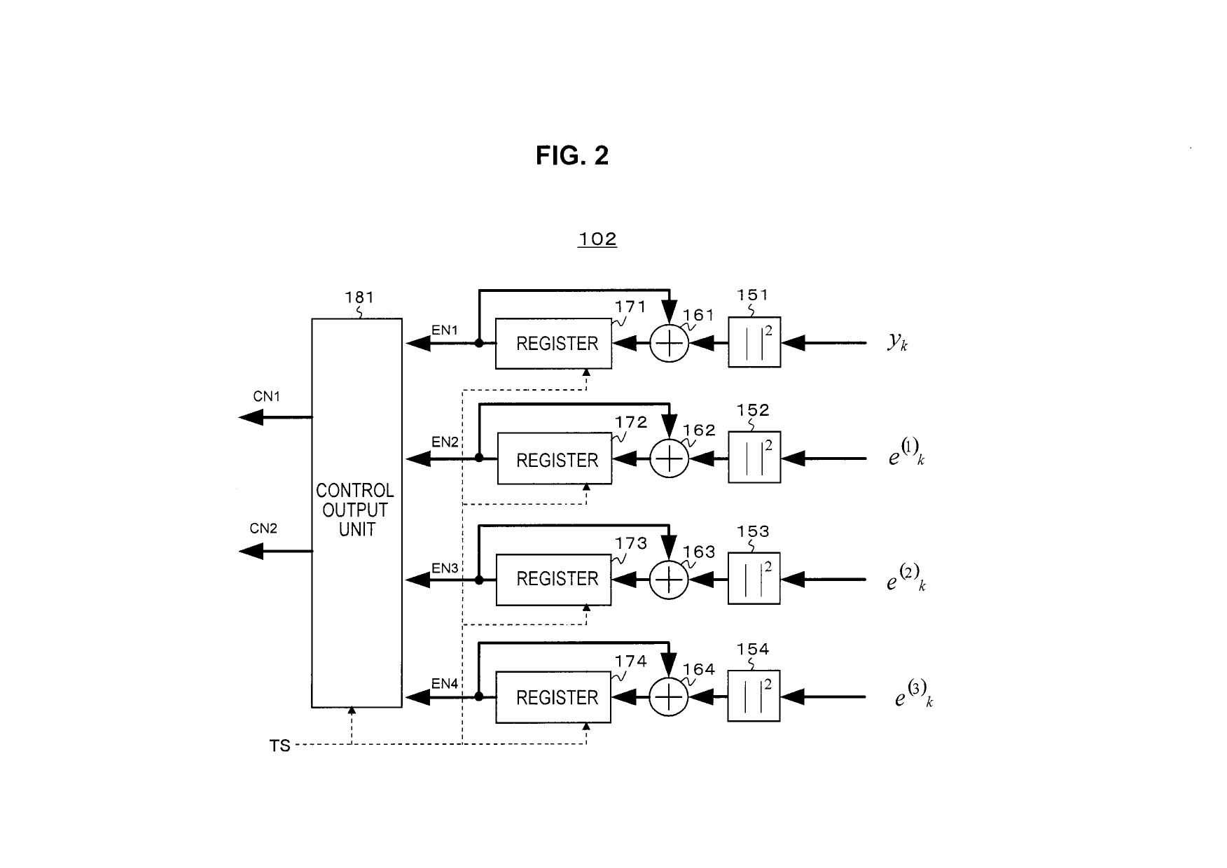

FIG. 2 shows a configuration example of the evaluation unit 102. The evaluation unit 102 determines whether the fixed period immediately before is a disturbance period by using the collected signal yk, the first error signal e(1)k, the second error signal e(2)k, and the third error signal e(3)k in every fixed period. The evaluation unit 102 includes absolute value square operation units 151 to 154, adders 161 to 164, registers 171 to 174, and a control output unit 181.

The absolute value square operation unit 151 performs an absolute value square operation on each piece of sample data of the collected signal yk to determine energy. The adder 161 adds the output of the absolute value square operation unit 151 to a hold value of the register 171 and supplies the added output to the register 171 to cause the register 171 to newly hold the added output. The hold value of the register 171 is cleared to zero at the start of each fixed period. Thus, the register 171 holds energy EN1 of the collected signal yk in each fixed period at the end of the fixed period.

The absolute value square operation unit 152 performs an absolute value square operation on each piece of sample data of the first error signal e(1)k determined by the subtractor 112 to determine energy. The adder 162 adds the output of the absolute value square operation unit 152 to a hold value of the register 172 and supplies the added output to the register 172 to cause the register 172 to newly hold the added output. The hold value of the register 172 is cleared to zero at the start of each fixed period. Thus, the register 172 holds energy EN2 of the first error signal e(1)k in each fixed period at the end of the fixed period.

The absolute value square operation unit 153 performs an absolute value square operation on each piece of sample data of the second error signal e(2)k determined by the subtractor 123 to determine energy. The adder 163 adds the output of the absolute value square operation unit 153 to a hold value of the register 173 and supplies the added output to the register 173 to cause the register 173 to newly hold the added output. The hold value of the register 173 is cleared to zero at the start of each fixed period. Thus, the register 173 holds energy EN3 of the second error signal e(2)k in each fixed period at the end of the fixed period.

The absolute value square operation unit 154 performs an absolute value square operation on each piece of sample data of the third error signal e(3)k determined by the subtractor 133 to determine energy. The adder 164 adds the output of the absolute value square operation unit 154 to a hold value of the register 174 and supplies the added output to the register 174 to cause the register 174 to newly hold the added output. The hold value of the register 174 is cleared to zero at the start of each fixed period. Thus, the register 174 holds energy EN4 of the third error signal e(3)k in each fixed period at the end of the fixed period.

The control output unit 181 determines whether the fixed period immediately before is a disturbance period in every fixed period based on the above energy in every fixed period to decide the values of the control signals CN1, CN2. If EN2/EN3>1.0, or EN(EN4, EN2, or EN3)/EN1<<1.0 and EN2/EN3>˜1.0, the control output unit 181 determines that the fixed period immediately before is not a disturbance period and sets CN1=1 and CN2=1. Otherwise, the control output unit 181 determines that the fixed period immediately before is a disturbance period and sets CN1=0 and CN2=0.

EN2/EN3>1 means that the second echo estimate y(2)k (hat) by the addition of the fixed section hfix (hat) and the holding section hsusp (hat) can make an error smaller than the first echo estimate y(1)k (hat) by the fixed section hfix (hat) alone. In this case, the holding section hsusp (hat) can be considered to make the fixed section hfix (hat) more precise and effective. EN(EN4, EN2, or EN3)/EN1<<1.0 and EN2/EN3>˜1.0 mean that the error signal is sufficiently small and a disturbance such as a double talk is small or there is no disturbance, though it is difficult to judge whether the holding section hsusp (hat) makes the error smaller.

The values of the control signals CN1, CN2 are decided based on the same criteria above, but the criteria may not necessarily be the same. For example, only if EN(EN4, EN2, or EN3)/EN1<<1.0 and EN2/EN3>˜1.0 for the control signal CN2, the fixed period immediately before may be determined to be a non-disturbance period to set CN2=1. Alternatively, for example, only if EN2/EN3>1.0 for the control signal CN1, the fixed period immediately before may be determined to be a non-disturbance period to set CN1=1.

[Operation of the Echo Removing Apparatus]

The operation of the echo removing apparatus 100 shown in FIG. 1 will be described. The input voice signal xk transmitted from the far end is supplied to the buffer unit 101. In the buffer unit 101, the input voice signal xk is temporarily accumulated to obtain the input voice signal vector xk=(xk−N−1, . . . , xk−2, xk−1, xk) vectorized with the sample size N that can cover the length of an echo. The input voice signal vector xk is supplied to the register units 111, 121, 131 and the multiplier 134.

The register unit 111 stores the fixed section hfix (hat) of a transfer characteristic estimation vector of order N. Then, the register unit 111 determines the inner product F1 of the input voice signal vector xk=(xk−N−1, . . . , xk−2, xk−1, xk) of order N from the buffer unit 101 and the determination unit hfix (hat) to determine the first echo estimate y(1)k (hat).

The first echo estimate y(1)k (hat) is supplied to the subtractor 112. Also, the collected signal (voice signal collected and obtained by the microphone MC) yk is supplied to the subtractor 112. The subtractor 112 subtracts the first echo estimate y(1)k (hat) from the voice signal yk to determine the first error signal e(1)k. The first error signal e(1)k is supplied to the evaluation unit 102 and the output selection unit 103.

The register unit 121 stores the holding section hsusp (hat) of the transfer characteristic estimation vector of order N. Then, the register unit 121 calculates the inner product value G1 of the input voice signal vector xk=(xk−N−1, . . . , xk−2, xk−1, xk) of order N output from the buffer unit 101 and the holding section hsusp (hat). The inner product value G1 is supplied to the adder 122. The inner product value F1 determined by the register unit 111 is also supplied to the adder 122.

The adder 122 adds the inner product value F1 and the inner product value G1 to determine the second echo estimate y(2)k (hat). The second echo estimate y(2)k (hat) is supplied to the subtractor 123. The collected signal yk is also supplied to the subtractor 123. The subtractor 123 subtracts the second echo estimate y(2)k (hat) from the collected signal yk to determine the second error signal e(2)k. The second error signal e(2)k is supplied to the evaluation unit 102.

The register unit 131 stores the update section hadapt (hat) of the transfer characteristic estimation vector of order N. Then, the register unit 131 determines the inner product value H1 of the input voice signal vector xk=(xk−N−1, . . . , xk−2, xk−1, xk) of order N output from the buffer unit 101 and the update section hadapt (hat). The inner product value H1 is supplied to the adder 132. The second echo estimate y(2)k (hat) determined by the adder 122 and thus, the added value of the inner product value F1 and the inner product value G1 are also supplied to the adder 132.

The adder 132 adds the inner product value H1 and the second echo estimate y(2)k (hat) to determine the third echo estimate y(3)k (hat). The third echo estimate y(3)k (hat) is supplied to the subtractor 133. The collected signal yk is also supplied to the subtractor 133. The subtractor 133 subtracts the third echo estimate y(3)k (hat) from the collected signal yk to determine the third error signal e(3)k. The third error signal e(3)k is supplied to the evaluation unit 102, the output selection unit 103, and the multiplier 134.

The multiplier 134 multiplies the input voice signal vector xk=(xk−N−1, . . . , xk−2, xk−1, xk) by the third error signal e(3)k. The output from the multiplier 134 is supplied to the adder 136 after being multiplied by the appropriate weight μ by the coefficient unit 135. The adder 136 cumulatively adds the output (N-dimensional vector) of the coefficient unit 135 to the update section hadapt (hat) of the transfer characteristic estimation vector of order N stored in the register unit 131.

Then, the register unit 131 stores the cumulatively added value as the new update section hadapt (hat) to update the update section hadapt (hat). Such an update operation of the update section hadapt (hat) by the register unit 131 is performed for each sample of the input voice signal xk.

The evaluation unit 102 (see FIG. 2) determines whether the fixed period immediately before is a disturbance period based on the voice signal yk, the first error signal e(1)k, the second error signal e(2)k, and the third error signal e(3)k in every fixed period. Then, the evaluation unit 102 outputs the control signals CN1, CN2 in accordance with the determination result in every fixed period. If, for example, the fixed period immediately before is determined to be a non-disturbance period, CN1=1 and CN2=1 are set and if the fixed period immediately before is determined to be a disturbance period, CN1=0 and CN2=0 are set.

The control signal CN1 output from the evaluation unit 102 is supplied to the connection switch 124. The connection switch 124 is controlled to a connected state or non-connected state based on the control signal CN1. That is, if the evaluation unit 102 determines that the fixed period immediately before is not a disturbance period, the connection switch 124 is set to a connected state and conversely if the evaluation unit 102 determines that the fixed period immediately before is a disturbance period, the connection switch 124 is set to a non-connected state.

The control signal CN2 output from the evaluation unit 102 is supplied to the output selection unit 103. The output selection unit 103 is controlled to a selected state of the first error signal e(1)k or a selected state of the third error signal e(3)k based on the control signal CN2. That is, if the evaluation unit 102 determines that the fixed period immediately before is not a disturbance period, the output selection unit 103 is set to a selected state of the third error signal e(3)k. Conversely, if the evaluation unit 102 determines that the fixed period immediately before is a disturbance period, the output selection unit 103 is set to a selected state of the first error signal e(1)k.

If the evaluation unit 102 determines that the fixed period immediately before is not a disturbance period, as described above, the connection switch 124 is set to a connected state based on the control signal CN1. Thus, the holding section hsusp (hat) of the transfer characteristic estimation vector of order N stored in the register unit 121 is supplied to the adder 113 through the connection switch 124. Then, in the adder 113, the holding section hsusp (hat) is cumulatively added to the fixed section hfix (hat) of the transfer characteristic estimation vector of order N stored in the register unit 111. Then, the register unit 111 stores the cumulatively added value as the new fixed section hfix (hat) based on the timing signal TS to update storage content.

At this point, the register unit 121 stores the update section adapt (hat) of the transfer characteristic estimation vector of order N stored in the register unit 131 based on the timing signal TS as the new holding section hsusp (hat). That is, the update section adapt (hat) is substituted into the holding section hsusp (hat). After the update section adapt (hat) of the transfer characteristic estimation vector of order N stored in the register unit 131 is substituted into the holding section hsusp (hat) as described above, the update section hadapt (hat) is cleared to zero.

At this point, as described above, the output selection unit 103 is set to a selected state of the third error signal e(3)k based on the control signal CN2. Thus, the third error signal e(3)k is output from the output selection unit 103 as the output voice signal nk (hat). This is because if there is no disturbance such as a double talk, the third error signal e(3)k has higher precision of echo cancellation.

On the other and, if the evaluation unit 102 determines that the fixed period immediately before is a disturbance period, as described above, the connection switch 124 is set to a non-connected state based on the control signal CN1. Thus, the fixed section hfix (hat) of the transfer characteristic estimation vector of order N stored in the register unit 111 is not updated.

At this point, the register unit 121 stores the update section adapt (hat) of the transfer characteristic estimation vector of order N stored in the register unit 131 based on the timing signal TS as the new holding section hsusp (hat). That is, the update section adapt (hat) is substituted into the holding section hsusp (hat). After the update section adapt (hat) of the transfer characteristic estimation vector of order N stored in the register unit 131 is substituted into the holding section hsusp (hat) as described above, the update section hadapt (hat) is cleared to zero.

At this point, as described above, the output selection unit 103 is set to a selected state of the first error signal e(1)k based on the control signal CN2. Thus, the first error signal e(1)k is output from the output selection unit 103 as the output voice signal nk (hat). This is because the first error signal e(1)k cancels echoes with stability even if there is a disturbance.

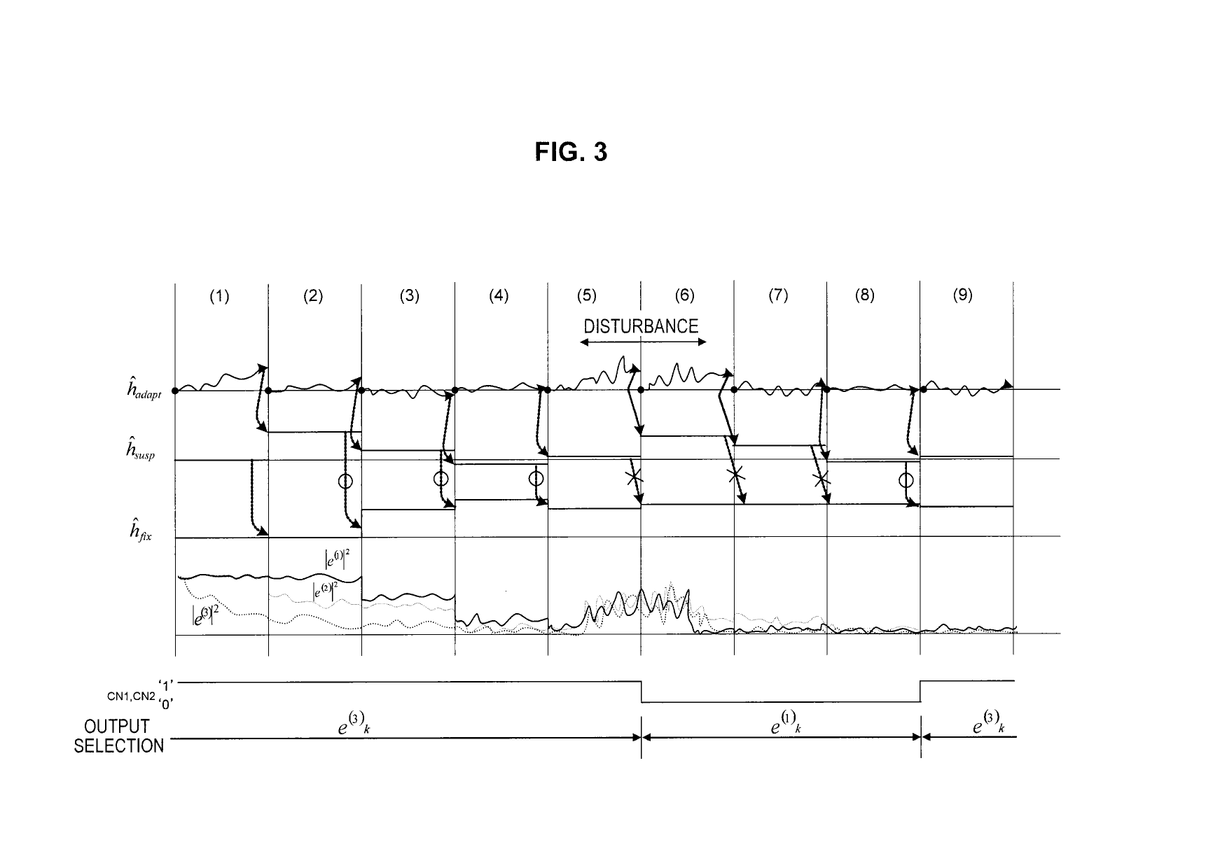

FIG. 3 is a diagram showing a transition example of the fixed section hfix (hat), the holding section hsusp (hat), and the update section hadapt (hat) of a transfer characteristic estimation vector, energy of the first, second, and third error signals e(1)k, e(2)k, e(3)k, an output selection and the like. In FIG. 3, (1), (2), . . . each show the above fixed periods.

The periods (1) to (4) are a convergence process from the initial state. Because the process is a convergence process, the error becomes gradually smaller. The energy of the second error signal e(2)k is smaller than the energy of the first error signal e(1)k and the holding section hsusp (hat) is cumulatively added to the fixed section hfix (hat) sequentially (see “O” marks) to gradually converge.

That is, the fixed period immediately before is determined to be a non-disturbance period at the end of the period (1) and the holding section hsusp (hat) is cumulatively added to the fixed section hfix (chat) to update the fixed section hfix (hat). At this point, the update section hadapt (hat) is substituted into the holding section hsusp (hat) and the update section hadapt (hat) is cleared to zero after the substitution. This also applies when each of the periods (2) to (4) ends.

In the periods (5), (6), a disturbance is input. Energy of each of the first, second, and third error signals e(1)k, e(2)k, e(3)k is larger than the disturbance and the update section hadapt (hat) takes disturbed values. Thus, the holding section hsusp (hat) is not cumulatively added (see “X” marks) to the fixed section hfix (hat) to avoid an influence of the disturbance. The holding section hsusp (hat) of the period (5) is an appropriate value before the disturbance starts, but is not added for safety.

That is, the fixed period immediately before is determined to be a disturbance period at the end of the period (5) and the holding section hsusp (hat) is not cumulatively added to the fixed section hfix (hat). At this point, the update section hadapt (hat) is substituted into the holding section hsusp (hat) and the update section hadapt (hat) is cleared to zero after the substitution. This also applies when the period (6) ends.

In the period (7), input of the disturbance has ended. However, the holding section hsusp (hat) is a value disturbed by the disturbance. Energy of each of the first, second, and third error signals e(1)k, e(2)k, e(3)k becomes smaller as a whole. However, the energy of the second error signal e(2)k containing an influence of the holding section hsusp (hat) under the influence of the disturbance becomes larger than the energy of the first error signal e(1)k.

Thus, the fixed period immediately before is determined to be a disturbance period at the end of the period (7) and the holding section hsusp (hat) is not cumulatively added to the fixed section hfix (hat) to avoid an influence of the disturbance. At this point, the update section hadapt (hat) is substituted into the holding section hsusp (hat) and the update section hadapt (hat) is cleared to zero after the substitution.

In the period (8) and thereafter, all of the fixed section hfix (hat), the holding section hsusp (hat), and the update section hadapt (hat) are not affected by a disturbance at all and a normal operation continues. That is, the fixed period immediately before is determined to be a non-disturbance period at the end of the period (8) and the holding section hsusp (hat) is cumulatively added to the fixed section hfix (hat) to update the fixed section hfix (hat). At this point, the update section hadapt (hat) is substituted into the holding section hsusp (hat) and the update section hadapt (hat) is cleared to zero after the substitution. This also applies to subsequent periods.

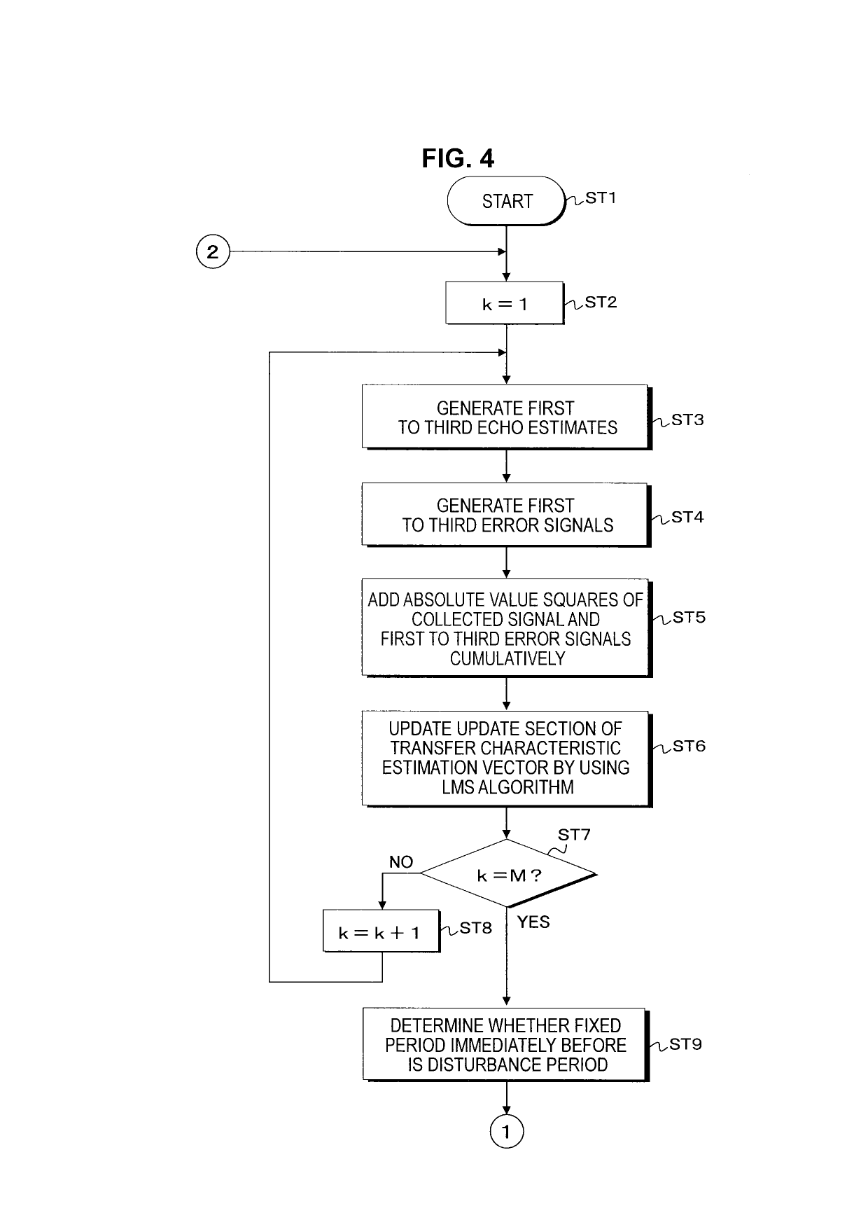

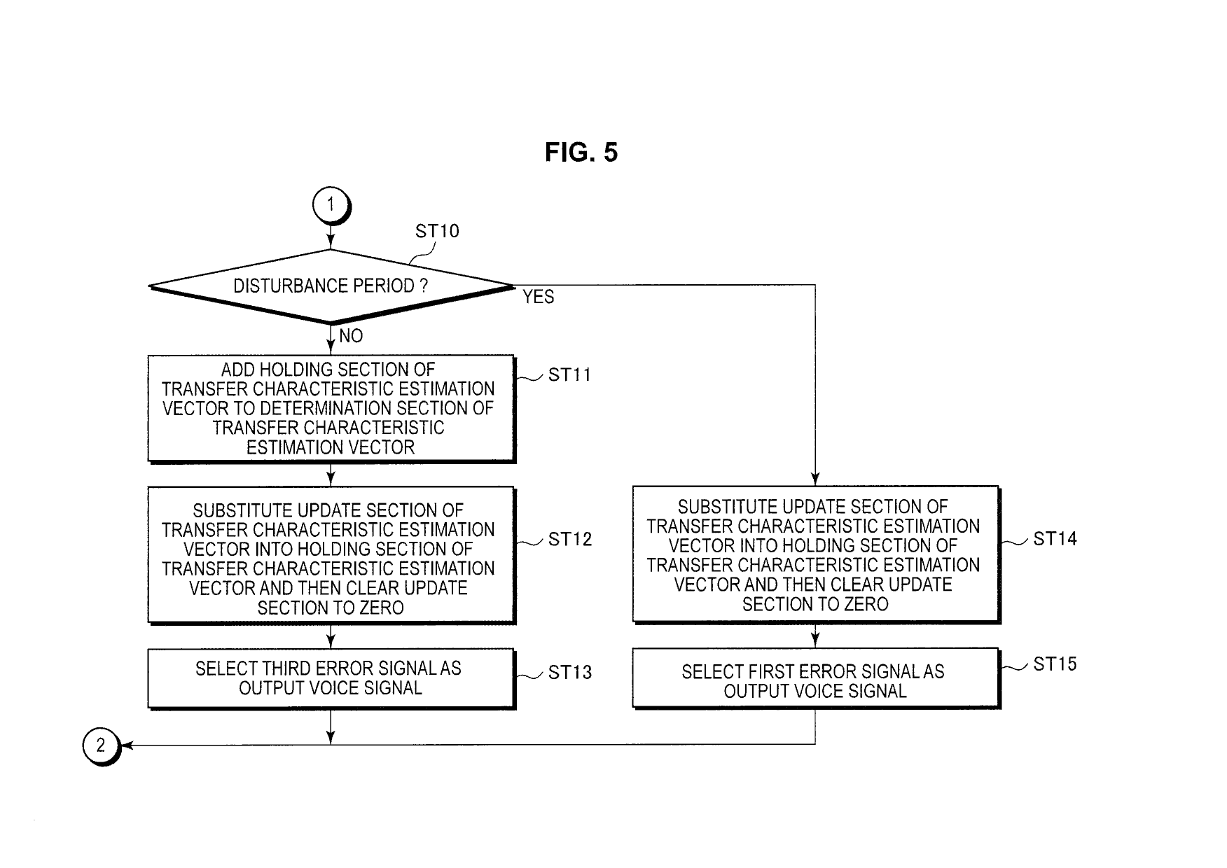

The flow charts in FIGS. 4 and 5 show an example of the processing procedure for echo removal for the echo removing apparatus 100 shown in FIG. 1. The echo removing apparatus 100 starts processing in step ST1 and sets k=1 in step ST2 before proceeding to processing in step ST3.

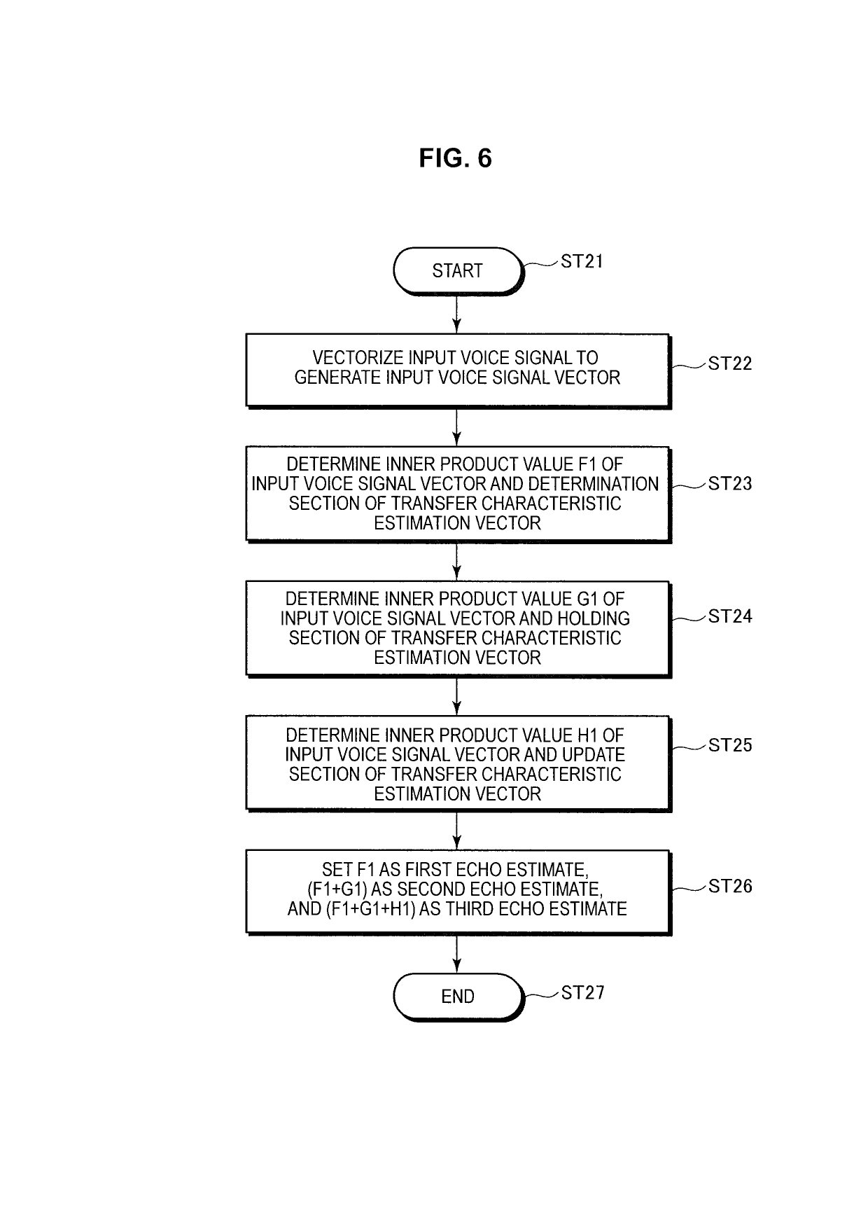

In step ST3, the echo removing apparatus 100 generates a first echo estimate y(1)k (hat), a second echo estimate y(2)k (hat), and a third echo estimate y(3)k (hat). The flow chart in FIG. 6 shows details of the processing in step ST3.

In step ST21, the echo removing apparatus 100 starts the processing and then proceeds to processing in step ST22. In step ST22, the echo removing apparatus 100 vectorizes an input voice signal xk transmitted from the far end to generate an input voice signal vector xk=(xk−N−1, . . . , xk−2, xk−1, xk).

Next, in step ST23, the echo removing apparatus 100 calculates an inner product of the input voice signal vector xk and the fixed section hfix (hat) of a transfer characteristic estimation vector to determine the inner product value F1. In step ST24, the echo removing apparatus 100 calculates an inner product of the input voice signal vector xk and the holding section hsusp (hat) of the transfer characteristic estimation vector to determine the inner product value G1. Further, in step ST25, the echo removing apparatus 100 calculates an inner product of the input voice signal vector xk and the update section hadapt (hat) of the transfer characteristic estimation vector to determine the inner product value H1. Incidentally, the order of processing from step ST23 to step ST25 is not limited to the illustrated order.

Next, in step ST26, the echo removing apparatus 100 sets the inner product value F1 determined in step ST23 as the first echo estimate y(1)k. Also in step ST26, the echo removing apparatus 100 sets an added value of the inner product value F1 determined in step ST23 and the inner product value G1 determined in step ST24 as the second echo estimate y(2)k. Further, also in step ST26, the echo removing apparatus 100 sets an added value of the second echo estimate y(2)k and the inner product value H1 determined in step ST25 as the third echo estimate y(3)k. After the processing in step ST26, in step ST27, the echo removing apparatus 100 terminates the processing.

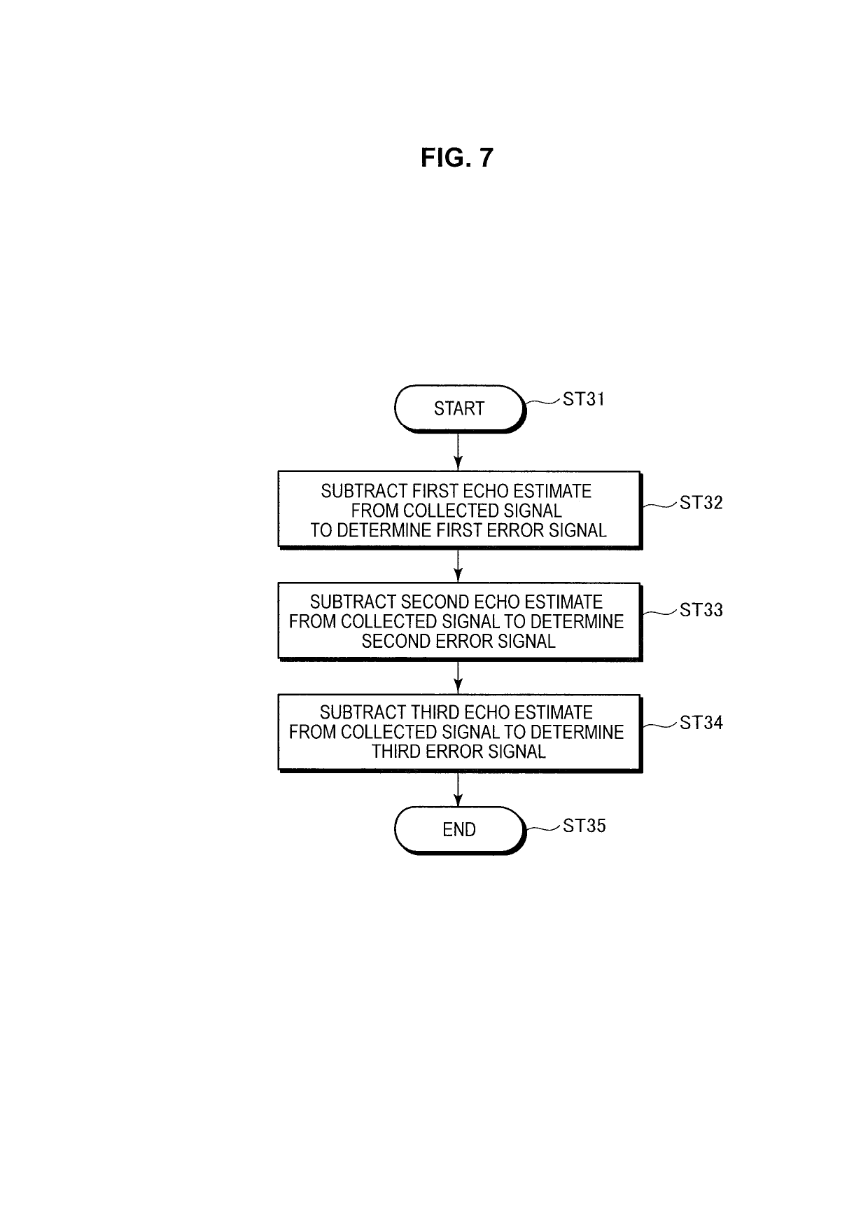

Returning to FIG. 4, after the processing in step ST3, the echo removing apparatus 100 proceeds to processing in step ST4. In step ST4, the echo removing apparatus 100 generates a first error signal e(1)k, a second error signal e(2)k, and a third error signal e(3)k. The flow chart in FIG. 7 shows details of the processing in step ST4.

In step ST31, the echo removing apparatus 100 starts the processing and then proceeds to processing in step ST32. In step ST32, the echo removing apparatus 100 subtracts the first echo estimate y(1)k (hat) from the collected signal (voice signal collected and obtained by the microphone MC) yk to determine the first error signal e(1)k.

Next, in step ST33, the echo removing apparatus 100 subtracts the second echo estimate y(2)k (hat) from the collected signal yk to determine the second error signal e(2)k. In step ST34, the echo removing apparatus 100 subtracts the third echo estimate y(3)k (hat) from the collected signal yk to determine the third error signal e(3)k. After the processing in step ST34, in step ST35, the echo removing apparatus 100 terminates the processing. Incidentally, the order of processing from step ST32 to step ST34 is not limited to the illustrated order.

Returning to FIG. 4, after the processing in step ST4, the echo removing apparatus 100 proceeds to processing in step ST5. In step ST5, the echo removing apparatus 100 determines an absolute value square (energy) of the collected signal yk and further, of each of the first error signal e(1)k, the second error signal e(2)k, and the third error signal e(3)k and then cumulatively adds these squares.

Next, in step ST6, the echo removing apparatus 100 updates the update section hadapt (hat) of the transfer characteristic estimation vector based on the third error signal e(3)k by using the LMS algorithm. After the processing in step ST6, the echo removing apparatus 100 proceeds to processing in step ST7.

In step ST7, the echo removing apparatus 100 determines whether k=M holds, that is, whether the fixed period (period of the sample size M) has passed. If k=M does not hold, the echo removing apparatus 100 increments k by 1 in step ST8 before returning to step ST3 to repeat the same processing as described above. On the other hand, if k=M holds, the echo removing apparatus 100 proceeds to processing in step ST9.

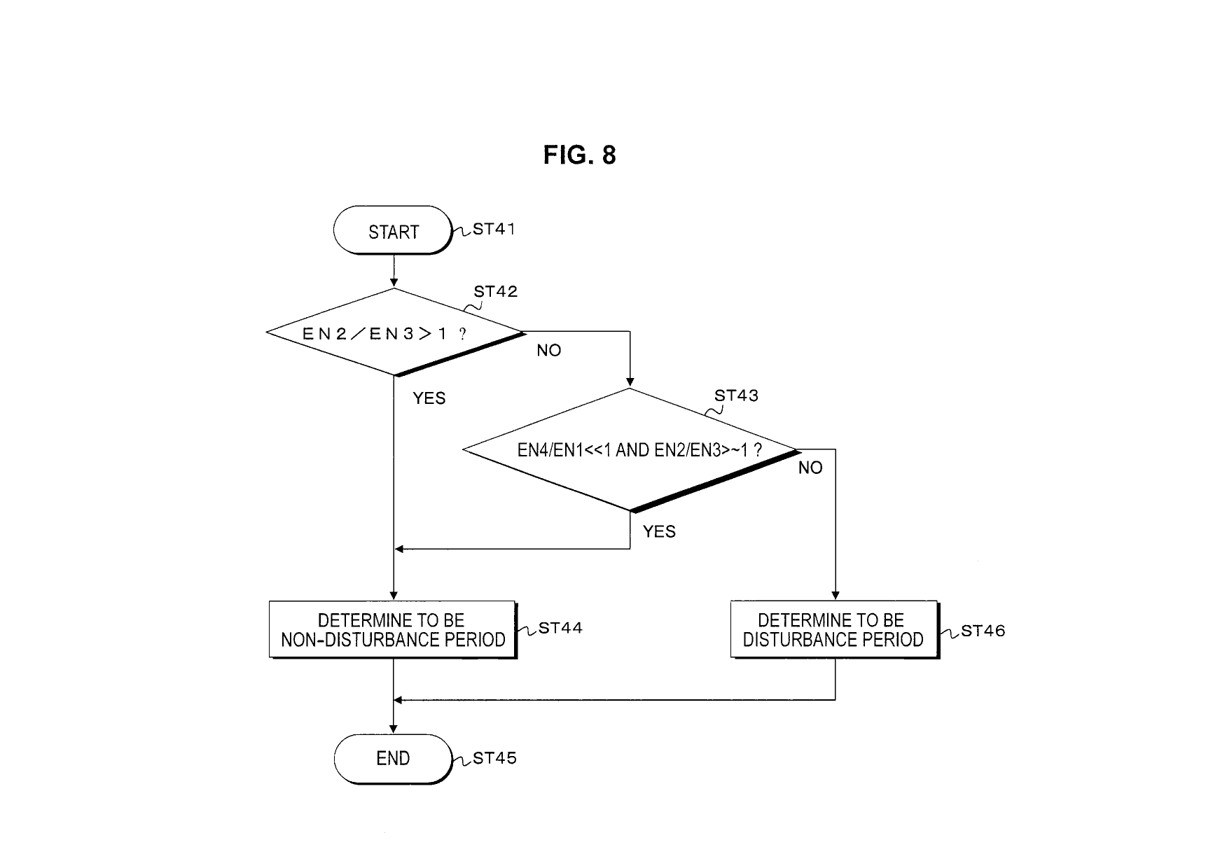

In step ST9, the echo removing apparatus 100 determines whether the fixed period immediately before is a disturbance period. The echo removing apparatus 100 makes a determination based on the energy EN1, EN2, EN3, EN4 of the collected signal yk, the first error signal e(1)k, the second error signal e(2)k, and the third error signal e(3)k in the fixed period immediately before respectively (see FIG. 2). The flow chart in FIG. 8 shows details of the processing in step ST9.

In step ST41, the echo removing apparatus 100 starts the processing and then proceeds to processing in step ST42. In step ST42, the echo removing apparatus 100 determines whether EN2/EN3>1.0 holds. If the condition is not satisfied in step ST42, in step ST43, the echo removing apparatus 100 determines whether EN4/EN1<<1.0 and EN2/EN3>˜1.0 hold.

If the condition is satisfied in step ST42 or the condition is satisfied in step ST43, the echo removing apparatus 100 determines that the fixed period immediately before is not a disturbance period in step ST44 and then terminates the processing in step ST45. On the other hand, if the condition is not satisfied in step ST43, the echo removing apparatus 100 determines that the fixed period immediately before is a disturbance period in step ST46 and then terminates the processing in step ST45.

Instead of EN4 in EN4/EN1<<1.0 in step ST43, EN2 or EN3 is may be used.

Returning to FIG. 4, after the processing in step ST9, the echo removing apparatus 100 proceeds to processing in step ST10 (see FIG. 5). In step ST10, whether the determination in step ST9 is a disturbance period is judged. If the determination is not a disturbance period, the echo removing apparatus 100 proceeds to processing in step ST11. In step ST11, the echo removing apparatus 100 cumulatively adds the holding section hsusp (hat) of the transfer characteristic estimation vector to the fixed section hfix (hat) of the transfer characteristic estimation vector.

Next, in step ST12, the echo removing apparatus 100 substitutes the update section hadapt (hat) of the transfer characteristic estimation vector into the holding section hsusp (hat) of the transfer characteristic estimation vector and then clears the update section hadapt (hat) to zero. Then, in step ST13, the echo removing apparatus 100 selects the third error signal e(3)k as the output voice signal nk (hat). After the processing in step ST13, the echo removing apparatus 100 returns to step ST2 to proceed to the processing of the next fixed period as described above.

On the other hand, if the determination is a disturbance period in step ST10, the echo removing apparatus 100 proceeds to processing in step ST14. In step ST14, the echo removing apparatus 100 substitutes the update section hadapt (hat) of the transfer characteristic estimation vector into the holding section hsusp (hat) of the transfer characteristic estimation vector and then clears the update section hadapt (hat) to zero. Then, in step ST15, the echo removing apparatus 100 selects the first error signal e(1)k as the output voice signal nk (hat). After the processing in step ST15, the echo removing apparatus 100 returns to step ST2 to proceed to the processing of the next fixed period as described above.

The echo removing apparatus 100 shown in FIG. 1 substitutes, as described above, the update section hadapt (hat) of the transfer characteristic estimation vector (transmission path estimate) as the holding section hsusp (hat) of the transmission path estimate in every fixed period. However, if the fixed period immediately before is determined to be a disturbance period, the holding section hsusp (hat) of the transfer characteristic estimation vector is not cumulatively added to the fixed section hfix (hat) of the transfer characteristic estimation vector. Thus, the fixed section hfix (hat) of the transfer characteristic estimation vector is not disturbed even if there is a disturbance and thus is resistant to disturbance.

If the fixed period immediately before is determined to be a disturbance period, the echo removing apparatus 100 shown in FIG. 1 selects the first error signal e(1)k as the output voice signal. The first error signal e(1)k is obtained by subtracting the first echo estimate y(1)k (hat) determined only by the fixed section hfix (hat) of the transfer characteristic estimation vector from the collected signal yk. Thus, a stable output voice signal nk (hat) whose echo component is canceled can be obtained.

The echo removing apparatus 100 shown in FIG. 1 obtains the third echo estimate y(3)k (hat) by using the input voice signal vector (input voice signal) xk and all transfer characteristic estimation vectors. All transfer characteristic estimation vectors include all fixed sections hfix (hat), holding sections hsusp (hat), and update sections hadapt (hat). Then, the third error signal e(3)k is obtained by subtracting the third echo estimate y(3)k (hat) from the collected signal yk. Then, based on the third error signal e(3)k, the update section hadapt (hat) of the transfer characteristic estimation vector is updated. Thus, the transmission path estimation of the fixed section hfix (hat), the holding section hsusp (hat), and the update section hadapt (hat) of the transfer characteristic estimation vector as a whole remains the same and convergence characteristics are not degraded.

### 2. Second Embodiment

### Configuration Example of the Echo Removing Apparatus

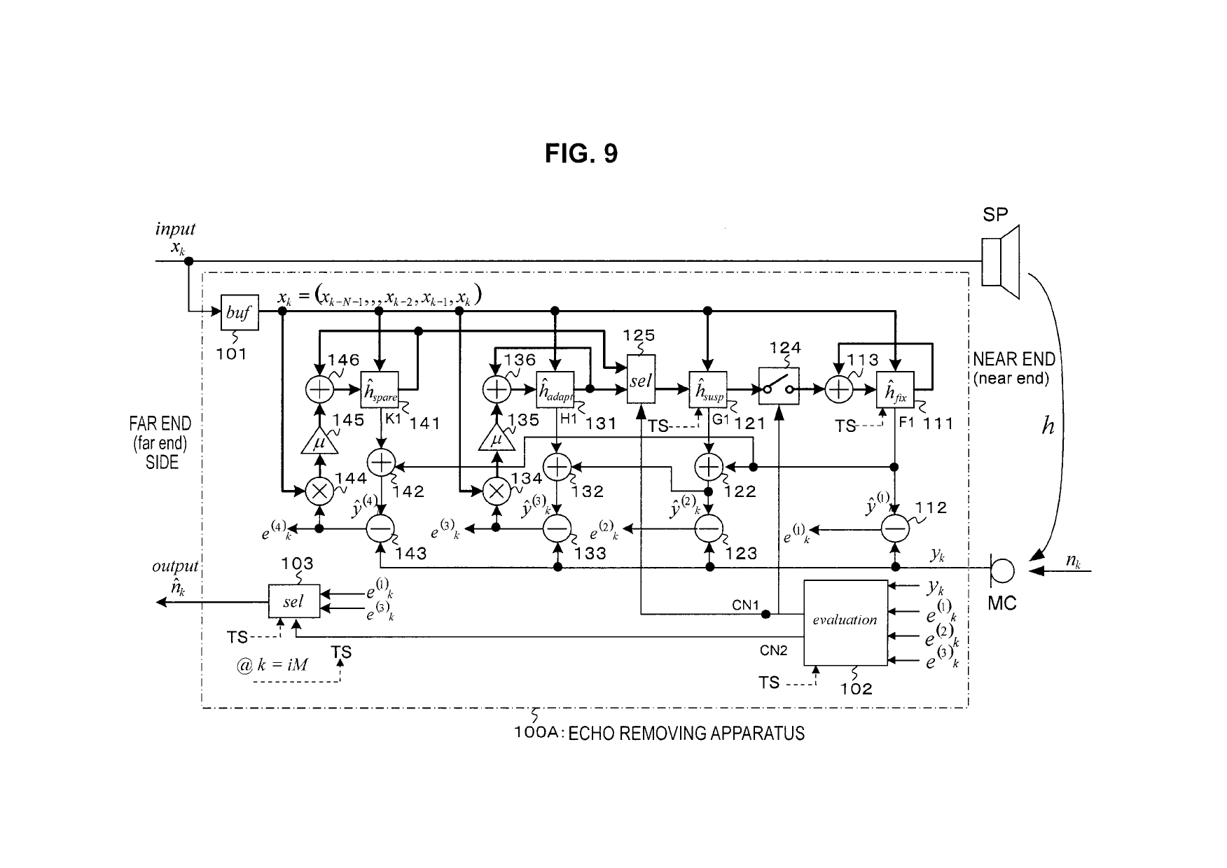

FIG. 9 shows a configuration example of an echo removing apparatus (echo canceller) 100A according to the second embodiment. In FIG. 9, the same reference numerals are attached to units corresponding to units in FIG. 1 and a detailed description thereof is omitted when appropriate. The echo removing apparatus 100A is configured, like the echo removing apparatus 100 shown in FIG. 1, to update the transfer characteristic estimation vector by using the LMS algorithm. In the description that follows, the echo removing apparatus 100A is assumed to be arranged at the near end.

The echo removing apparatus 100A includes the buffer unit 101, the evaluation unit 102, and the output selection unit 103. The echo removing apparatus 100A also includes the register unit 111, the subtractor 112, and the adder 113. The echo removing apparatus 100A also includes the register unit 121, the adder 122, the subtractor 123, the connection switch 124, and a selector 125. The echo removing apparatus 100A also includes the register unit 131, the adder 132, the subtractor 133, the multiplier 134, the coefficient unit 135, and the adder 136. Further, the echo removing apparatus 100A also includes a register unit 141, an adder 142, a subtractor 143, a multiplier 144, a coefficient unit 145, and an adder 146.

The selector 125 selectively supplies the update section hadapt (hat) of a transfer characteristic estimation vector stored in the register unit 131 or the update section hspare (hat) of a transfer characteristic estimation vector stored in the register unit 141 to the register unit 121. The update section hadapt (hat) constitutes a first update section and the update section hspare (hat) constitutes a second update section.

The selector 125 is set to a selected state of the update section hadapt (hat) or a selected state of the update section hspare (hat) based on the control signal CN1 obtained by the evaluation unit 102. That is, if the evaluation unit 102 determines that the fixed period immediately before is not a disturbance period, the selector 125 is set to a selected state of the update section hadapt (hat). If the evaluation unit 102 determines that the fixed period immediately before is a disturbance period, the selector 125 is set to a selected state of the update section hspare (hat).

The register unit 121 stores the update section adapt (hat) or the update section spare (hat) supplied through the selector 125 as the holding section hsusp (hat) in every fixed period based on the timing signal TS. That is, the update section adapt (hat) or the update section spare (hat) is substituted into the holding section hsusp (hat) in every fixed period. After the holding section hsusp (hat) is updated by the substitution, both the update section adapt (hat) and the update section spare (hat) are cleared to zero.

The register unit 141 stores the update section hspare (hat) of the transfer characteristic estimation vector of order N. The register unit 141 also calculates an inner product of the input voice signal vector xk=(xk−N−1, . . . , xk−2, xk−1, xk) output from the buffer unit 101 and the update section hspare (hat) of the transfer characteristic estimation vector of order N.

The adder 142 adds an inner product value K1 determined by the register unit 141 and the inner product value F1 determined by the register unit 111 to determine a fourth echo estimate y(4)k (hat). The subtractor 143 subtracts the fourth echo estimate y(4)k (hat) determined by the adder 142 from the collected signal (voice signal collected and obtained by the microphone MC) yk to determine a fourth error signal e(4)k.

The multiplier 144 multiplies the input voice signal vector xk=(xk−N−1, . . . , xk−2, xk−1, xk) output from the buffer unit 101 by the fourth error signal e(4)k determined by the subtractor 143. The coefficient unit 145 multiplies the output of the multiplier 144 by the appropriate weight μ (for example, 0.01 or the like). The adder 146 cumulatively adds the output (N-dimensional vector) of the coefficient unit 145 to the update section hspare (hat) of the transfer characteristic estimation vector of order N stored in the register unit 141. The register unit 141 stores the cumulatively added value as the update section hspare (hat) of a new transfer characteristic estimation vector of order N to update storage content.

Otherwise, the echo removing apparatus 100A shown in FIG. 9 is configured in the same manner as the echo removing apparatus 100 shown in FIG. 1.

[Operation of the Echo Removing Apparatus]

The operation of the echo removing apparatus 100A shown in FIG. 9 will be described. The input voice signal xk transmitted from the far end is supplied to the buffer unit 101. In the buffer unit 101, the input voice signal xk is temporarily accumulated to obtain the input voice signal vector xk=(xk−N−1, . . . , xk−2, xk−1, xk) vectorized with the sample size N that can cover the length of an echo. The input voice signal vector xk is supplied to the register units 111, 121, 131, 141 and the multipliers 134, 144.

The register unit 111 stores the fixed section hfix (hat) of a transfer characteristic estimation vector of order N. Then, the register unit 111 calculates the inner product F1 of the input voice signal vector xk=(xk−N−1, . . . , xk−2, xk−1, xk) of order N from the buffer unit 101 and the determination unit hfix ( ) to determine the first echo estimate y(1)k (hat). The first echo estimate y(1)k (hat) is supplied to the subtractor 112.

The first echo estimate y(1)k (hat) is supplied to the subtractor 112. Also, the collected signal (voice signal collected and obtained by the microphone MC) yk is supplied to the subtractor 112. The subtractor 112 subtracts the first echo estimate y(1)k (hat) from the voice signal yk to determine the first error signal e(1)k. The first error signal e(1)k is supplied to the evaluation unit 102 and the output selection unit 103.

The register unit 121 stores the holding section hsusp (hat) of the transfer characteristic estimation vector of order N. Then, the register unit 121 determines the inner product value G1 of the input voice signal vector xk=(xk−N−1, . . . , xk−2, xk−1, xk) of order N output from the buffer unit 101 and the holding section hsusp (hat). The inner product value G1 is supplied to the adder 122. The inner product value F1 determined by the register unit 111 is also supplied to the adder 122.

The adder 122 adds the inner product value F1 and the inner product value G1 to determine the second echo estimate y(2)k (hat). The second echo estimate y(2)k (hat) is supplied to the subtractor 123. The collected signal yk is also supplied to the subtractor 123. The subtractor 123 subtracts the second echo estimate y(2)k (hat) from the collected signal yk to determine the second error signal e(2)k. The second error signal e(2)k is supplied to the evaluation unit 102.

The register unit 131 stores the update section hadapt (hat) of the transfer characteristic estimation vector of order N. Then, the register unit 131 calculates the inner product value H1 of the input voice signal vector xk=(xk−N−1, . . . , xk−2, xk−1, xk) of order N output from the buffer unit 101 and the update section hadapt (hat). The inner product value H1 is supplied to the adder 132. The second echo estimate y(2)k (hat) determined by the adder 122 and thus, the added value of the inner product value F1 and the inner product value G1 are also supplied to the adder 132.

The adder 132 adds the inner product value H1 and the second echo estimate y(2)k (hat) to determine the third echo estimate y(3)k (hat). The third echo estimate y(3)k (hat) is supplied to the subtractor 133. The collected signal yk is also supplied to the subtractor 133. The subtractor 133 subtracts the third echo estimate y(3)k (hat) from the collected signal yk to determine the third error signal e(3)k. The third error signal e(3)k is supplied to the evaluation unit 102, the output selection unit 103, and the multiplier 134.

The multiplier 134 multiplies the input voice signal vector xk=(xk−N−1, . . . , xk−2, xk−1, xk) by the third error signal e(3)k. The output from the multiplier 134 is supplied to the adder 136 after being multiplied by the appropriate weight μ by the coefficient unit 135. The adder 136 cumulatively adds the output (N-dimensional vector) of the coefficient unit 135 to the update section hadapt (hat) of the transfer characteristic estimation vector of order N stored in the register unit 131.

Then, the register unit 131 stores the cumulatively added value as the new update section hadapt (hat) to update the update section hadapt (hat). Such an update operation of the update section hadapt (hat) by the register unit 131 is performed for each sample of the input voice signal xk.

The register unit 141 stores the update section hspare (hat) of the transfer characteristic estimation vector of order N. Then, the register unit 141 determines the inner product value K1 of the input voice signal vector xk=(xk−N−1, . . . , xk−2, xk−1, xk) of order N output from the buffer unit 101 and the update section hspare (hat). The inner product value K1 is supplied to the adder 142. The inner product value F1 (first echo estimate y(1)k (hat)) determined by the register unit 111 is also supplied to the adder 142.

The adder 142 adds the inner product value K1 and the inner product value F1 to determine the fourth echo estimate y(4)k (hat). The fourth echo estimate y(4)k (hat) is supplied to the subtractor 143. The collected signal yk is also supplied to the subtractor 143. The subtractor 143 subtracts the fourth echo estimate y(4)k (hat) from the collected signal yk to determine the fourth error signal e(4)k. The fourth error signal e(4)k is supplied to the multiplier 144.

The multiplier 144 multiplies the input voice signal vector xk=(xk−N−1, . . . , xk−2, xk−1, xk) by the fourth error signal e(4)k. The output from the multiplier 144 is supplied to the adder 146 after being multiplied by the appropriate weight μ by the coefficient unit 145. The adder 146 cumulatively adds the output (N-dimensional vector) of the coefficient unit 145 to the update section hspare (hat) of the transfer characteristic estimation vector of order N stored in the register unit 141.

Then, the register unit 141 stores the cumulatively added value as the new update section hspare (hat) to update the update section hspare (hat). Such an update operation of the update section hspare (hat) by the register unit 131 is performed for each sample of the input voice signal xk.

The evaluation unit 102 (see FIG. 2) determines whether the fixed period immediately before is a disturbance period based on the voice signal yk, the first error signal e(1)k, the second error signal e(2)k, and the third error signal e(3)k in every fixed period. Then, the evaluation unit 102 outputs the control signals CN1, CN2 in accordance with the determination result in every fixed period. If, for example, the fixed period immediately before is determined to be a non-disturbance period, CN1=1 and CN2=1 are set and if the fixed period immediately before is determined to be a disturbance period, CN1=0 and CN2=0 are set.

The control signal CN1 output from the evaluation unit 102 is supplied to the connection switch 124. The connection switch 124 is controlled to a connected state or non-connected state based on the control signal CN1. That is, if the evaluation unit 102 determines that the fixed period immediately before is not a disturbance period, the connection switch 124 is set to a connected state and conversely if the evaluation unit 102 determines that the fixed period immediately before is a disturbance period, the connection switch 124 is set to a non-connected state.

The control signal CN1 output from the evaluation unit 102 is supplied to the selector 125. The selector 125 is set to a selected state of the update section hadapt (hat) or a selected state of the update section hspare (hat) based on the control signal CN1. That is, if the evaluation unit 102 determines that the fixed period immediately before is not a disturbance period, the selector 125 is set to a selected state of the update section hadapt (hat). If the evaluation unit 102 determines that the fixed period immediately before is a disturbance period, the selector 125 is set to a selected state of the update section hspare (hat).

The control signal CN2 output from the evaluation unit 102 is supplied to the output selection unit 103. The output selection unit 103 is controlled to a selected state of the first error signal e(1)k or a selected state of the third error signal e(3)k based on the control signal CN2. That is, if the evaluation unit 102 determines that the fixed period immediately before is not a disturbance period, the output selection unit 103 is set to a selected state of the third error signal e(3)k. Conversely, if the evaluation unit 102 determines that the fixed period immediately before is a disturbance period, the output selection unit 103 is set to a selected state of the first error signal e(1)k.

If the evaluation unit 102 determines that the fixed period immediately before is not a disturbance period, as described above, the connection switch 124 is set to a connected state based on the control signal CN1. Thus, the holding section hsusp (hat) of the transfer characteristic estimation vector of order N stored in the register unit 121 is supplied to the adder 113 through the connection switch 124. Then, in the adder 113, the holding section hsusp (hat) is cumulatively added to the fixed section hfix (hat) of the transfer characteristic estimation vector of order N stored in the register unit 111. Then, the register unit 111 stores the cumulatively added value as the new fixed section hfix (hat) based on the timing signal TS to update storage content.

At this point, as described above, the selector 125 is set to a selected state of the update section adapt (hat) based on the control signal CN1 and the update section hadapt (hat) of the transfer characteristic estimation vector stored in the register unit 131 is supplied to the register unit 121. Thus, the update section adapt (hat) of the transfer characteristic estimation vector of order N stored in the register unit 131 is stored in the register unit 121 based on the timing signal TS as the new holding section hsusp (hat). That is, the update section adapt (hat) is substituted into the holding section hsusp (hat). After the holding section hsusp (hat) is updated by the substitution, both the update section hadapt (hat) and the update section hspare (hat) are cleared to zero.

At this point, as described above, the output selection unit 103 is set to a selected state of the third error signal e(3)k based on the control signal CN2. Thus, the third error signal e(3)k is output from the output selection unit 103 as the output voice signal nk (hat). This is because if there is no disturbance such as a double talk, the third error signal e(3)k has higher precision of echo cancellation.

On the other and, if the evaluation unit 102 determines that the fixed period immediately before is a disturbance period, as described above, the connection switch 124 is set to a non-connected state based on the control signal CN1. Thus, the fixed section hfix (hat) of the transfer characteristic estimation vector of order N stored in the register unit 111 is not updated.

At this point, as described above, the selector 125 is set to a selected state of the update section hspare (hat) based on the control signal CN1 and the update section spare (hat) of the transfer characteristic estimation vector stored in the register unit 141 is supplied to the register unit 121. Thus, the update section spare (hat) of the transfer characteristic estimation vector of order N stored in the register unit 141 is stored in the register unit 121 based on the timing signal TS as the new holding section hsusp (hat). That is, the update section spare (hat) is substituted into the holding section hsusp (hat). After the holding section hsusp (hat) is updated by the substitution, both the update section hadapt (hat) and the update section hspare (hat) are cleared to zero.

At this point, as described above, the output selection unit 103 is set to a selected state of the first error signal e(1)k based on the control signal CN2. Thus, the first error signal e(1)k is output from the output selection unit 103 as the output voice signal nk (hat). This is because the first error signal e(1)k cancels echoes with stability even if there is a disturbance.

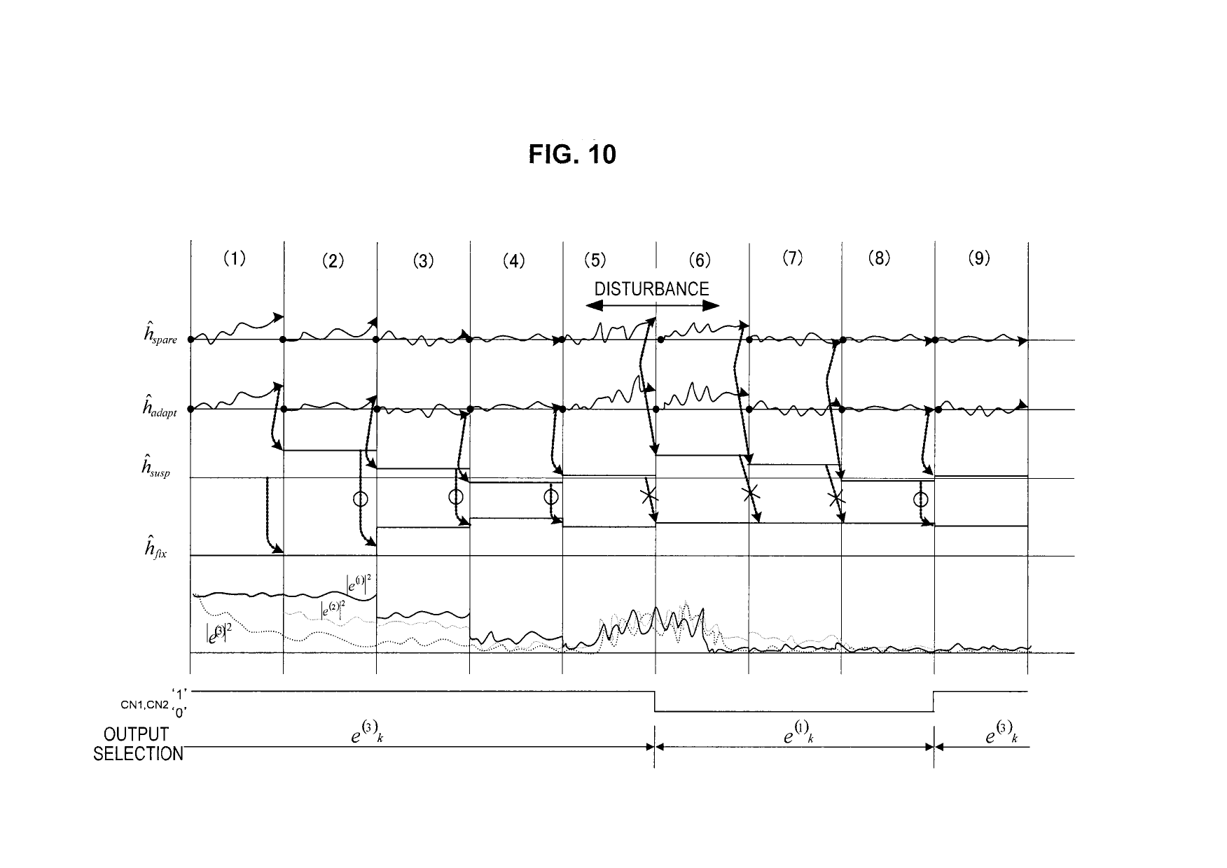

FIG. 10 shows a transition example of the fixed section hfix (hat), the holding section hsusp (hat), the update section hadapt (hat), and the update section hspare (hat) of the transfer characteristic estimation vector, energy of the first, second, and third error signals e(1)k, e(2)k, e(3)k, the output selection and the like. In FIG. 10, (1), (2), . . . each show the above fixed periods.

The periods (1) to (4) are a convergence process from the initial state. Because the process is a convergence process, the error becomes gradually smaller. The energy of the second error signal e(2)k is smaller than the energy of the first error signal e(1)k and the holding section hsusp (hat) is cumulatively added to the fixed section hfix (hat) sequentially (see “O” marks) to gradually converge.

That is, the fixed period immediately before is determined to be a non-disturbance period at the end of the period (1) and the holding section hsusp (hat) is cumulatively added to the fixed section hfix (hat) to update the fixed section hfix (hat). At this point, the update section hadapt (hat) is substituted into the holding section hsusp (hat) and the update section hadapt (hat) and the update section hspare (hat) are cleared to zero after the substitution. This also applies when each of the periods (2) to (4) ends.

In the periods (5), (6), a disturbance is input. Energy of each of the first, second, and third error signals e(1)k, e(2)k, e(3)k is larger than the disturbance and the update section hadapt (hat) takes disturbed values. Thus, the holding section hsusp (hat) is not cumulatively added (see “X” marks) to the fixed section hfix (hat) to avoid an influence of the disturbance. The holding section hsusp (hat) of the period (5) is an appropriate value before the disturbance starts, but is not added for safety.

That is, the fixed period immediately before is determined to be a disturbance period at the end of the period (5) and the holding section hsusp (hat) is not cumulatively added to the fixed section hfix (hat). At this point, the update section hspare (hat) is substituted into the holding section hsusp (hat) and the update section hadapt (hat) and the update section hspare (hat) are cleared to zero after the substitution. This also applies when the period (6) ends.

In the period (7), input of the disturbance has ended. However, the holding section hsusp (hat) is a value disturbed by the disturbance. Energy of each of the first, second, and third error signals e(1)k, e(2)k, e(3)k becomes smaller as a whole. However, the energy of the second error signal e(2)k containing an influence of the holding section hsusp (hat) under the influence of the disturbance becomes larger than the energy of the first error signal e(1)k.

Thus, the fixed period immediately before is determined to be a disturbance period at the end of the period (7) and the holding section hsusp (hat) is not cumulatively added to the fixed section hfix (hat) to avoid an influence of the disturbance. At this point, the update section hspare (hat) is substituted into the holding section hsusp (hat). That is, in this case, what is substituted into the holding section hsusp (hat) is not the update section hadapt (hat), but the update section hspare (hat) not affected by a disturbance. After the substitution, the update section hadapt (hat) and the update section hspare (hat) are cleared to zero.

In the period (8) and thereafter, all of the fixed section hfix (hat), the holding section hsusp (hat), the update section hadapt (hat), and the update section hspare (hat) are not affected by a disturbance at all and a normal operation continues. That is, the fixed period immediately before is determined to be a non-disturbance period at the end of the period (8) and the holding section hsusp (hat) is cumulatively added to the fixed section hfix (hat) to update the fixed section hfix (hat). At this point, the update section hadapt (hat) is substituted into the holding section hsusp (hat) and the update section hadapt (hat) and the update section hspare (hat) are cleared to zero after the substitution. This also applies to subsequent periods.

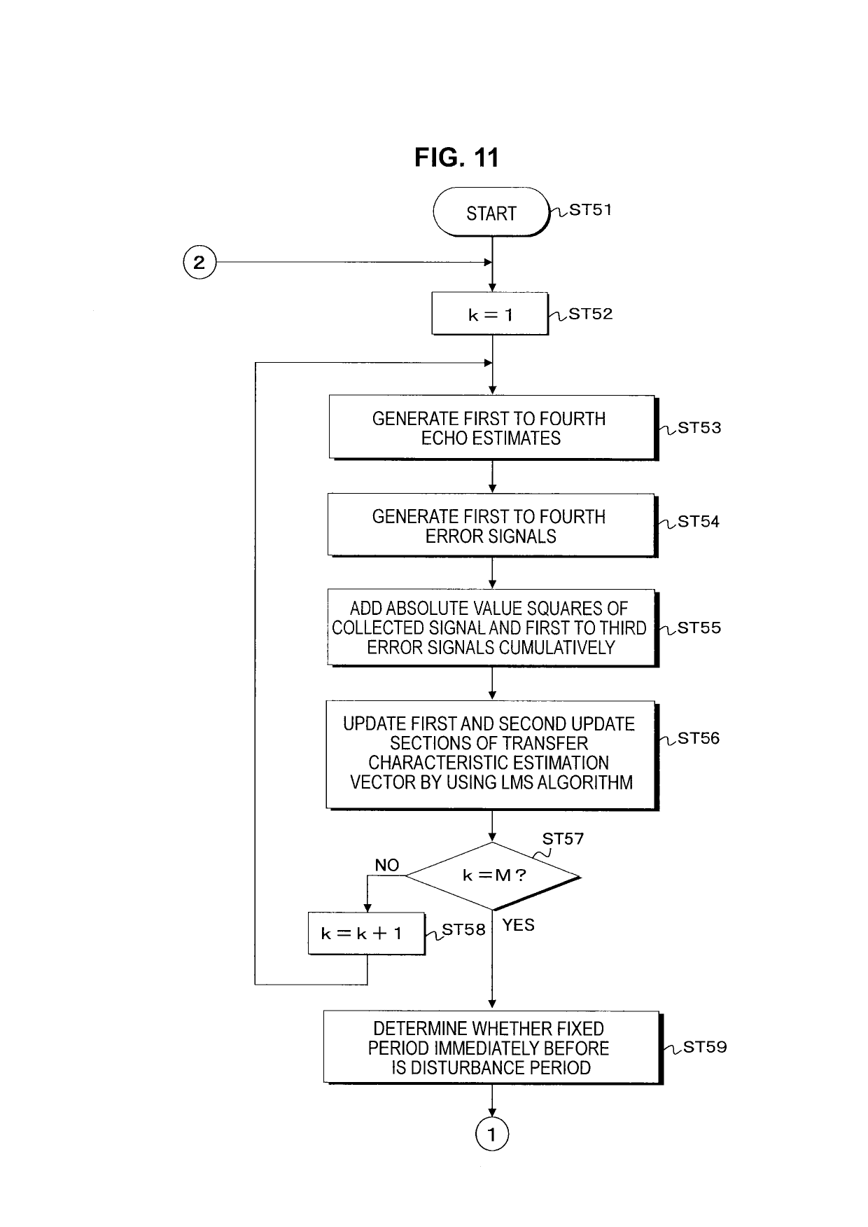

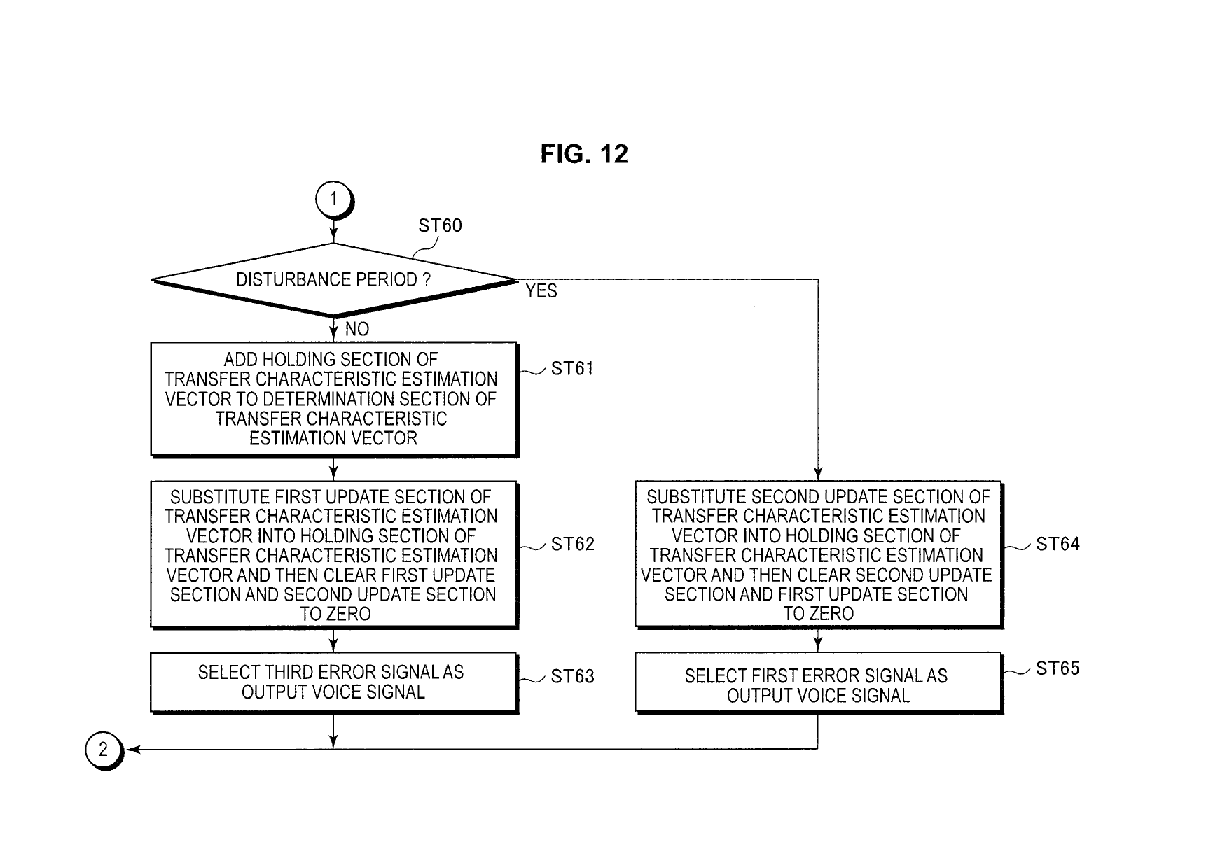

The flow charts in FIGS. 11 and 12 show an example of the processing procedure for echo removal for the echo removing apparatus 100A shown in FIG. 9. The echo removing apparatus 100A starts processing in step ST51 and sets k=1 in step ST52 before proceeding to processing in step ST53.

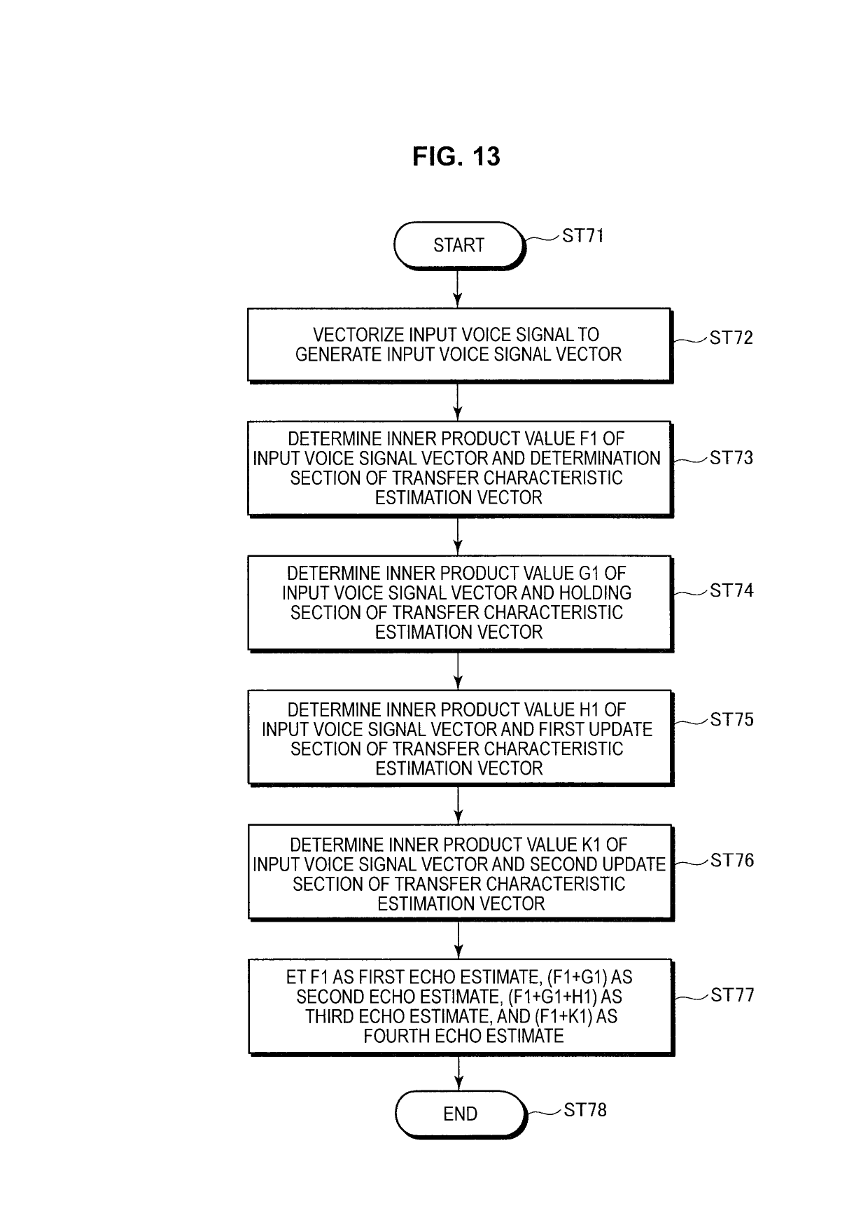

In step ST53, the echo removing apparatus 100A generates a first echo estimate y(1)k (hat), a second echo estimate y(2)k (hat), a third echo estimate y(3)k (hat), and a fourth echo estimate y(4)k (hat). The flow chart in FIG. 13 shows details of the processing in step ST53.

The echo removing apparatus 100A starts processing in step ST71 and then proceeds to processing in step ST72. In step ST72, the echo removing apparatus 100A vectorizes an input voice signal xk transmitted from the far end to generate an input voice signal vector xk=(xk−N−1, . . . , xk−2, xk−1, xk).

Next, in step ST73, the echo removing apparatus 100A calculates an inner product of the input voice signal vector xk and the fixed section hfix (hat) of a transfer characteristic estimation vector to determine the inner product value F1. In step ST74, the echo removing apparatus 100A calculates an inner product of the input voice signal vector xk and the holding section hsusp (hat) of the transfer characteristic estimation vector to determine the inner product value G1.

In step ST75, the echo removing apparatus 100A calculates an inner product of the input voice signal vector xk and the update section hadapt (hat) of the transfer characteristic estimation vector to determine the inner product value H1. Further, in step ST76, the echo removing apparatus 100A calculates an inner product of the input voice signal vector xk and the update section hspare (hat) of the transfer characteristic estimation vector to determine the inner product value K1. Incidentally, the order of processing from step ST73 to step ST76 is not limited to the illustrated order.

Next, in step ST77, the echo removing apparatus 100A sets the inner product value F1 determined in step ST73 as the first echo estimate y(1)k. Also in step ST77, the echo removing apparatus 100A sets an added value of the inner product value F1 determined in step ST73 and the inner product value G1 determined in step ST74 as the second echo estimate y(2)k.

Further, in step ST77, the echo removing apparatus 100A sets an added value of the inner product value F1 determined in step ST73 and the inner product value K1 determined in step ST76 as the fourth echo estimate y(4)k. After the processing in step ST77, in step ST78, the echo removing apparatus 100A terminates the processing.

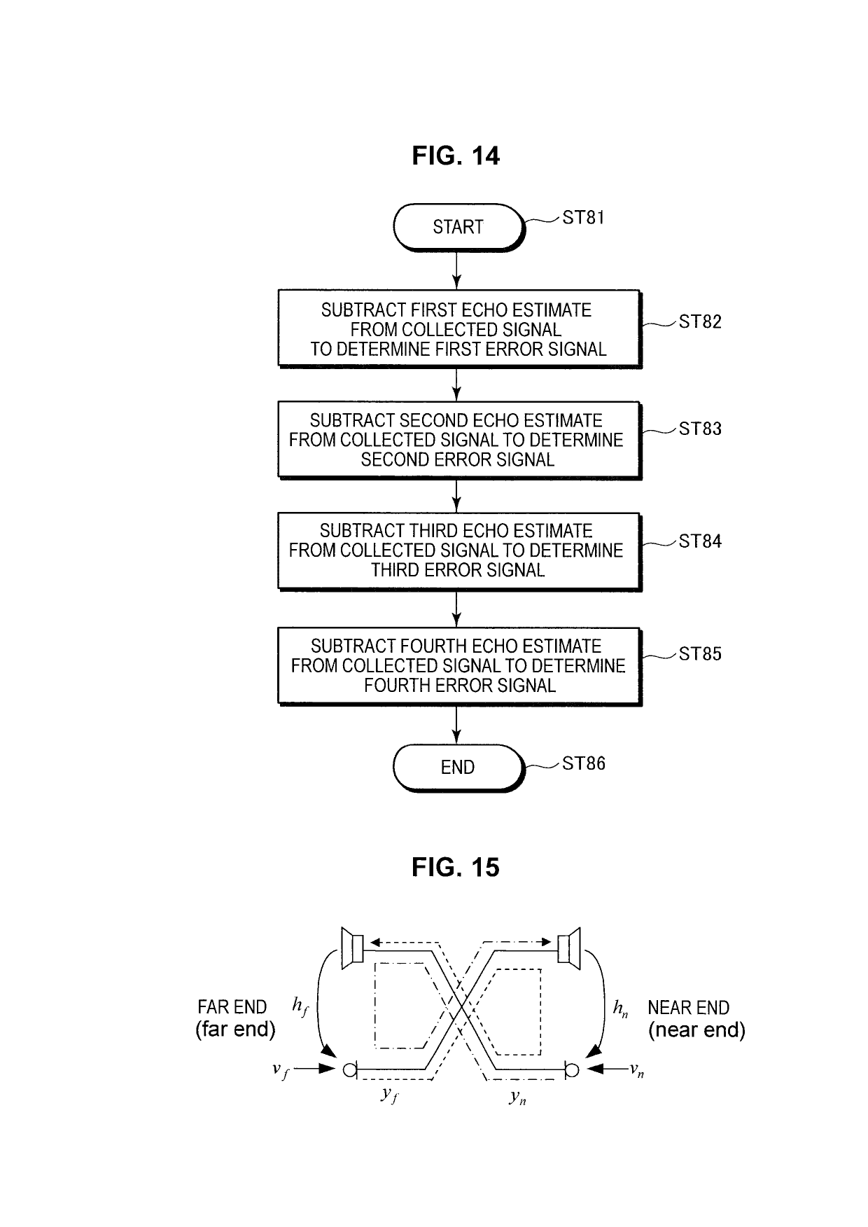

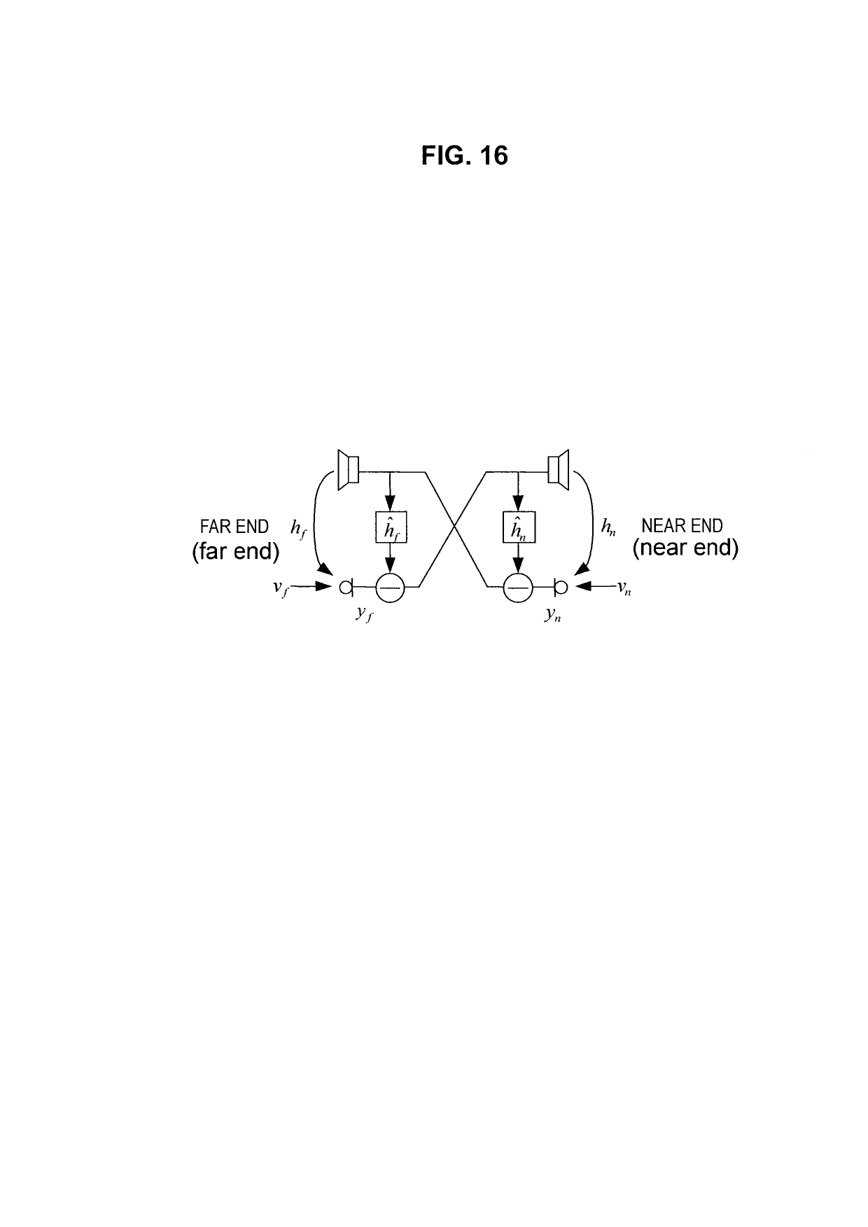

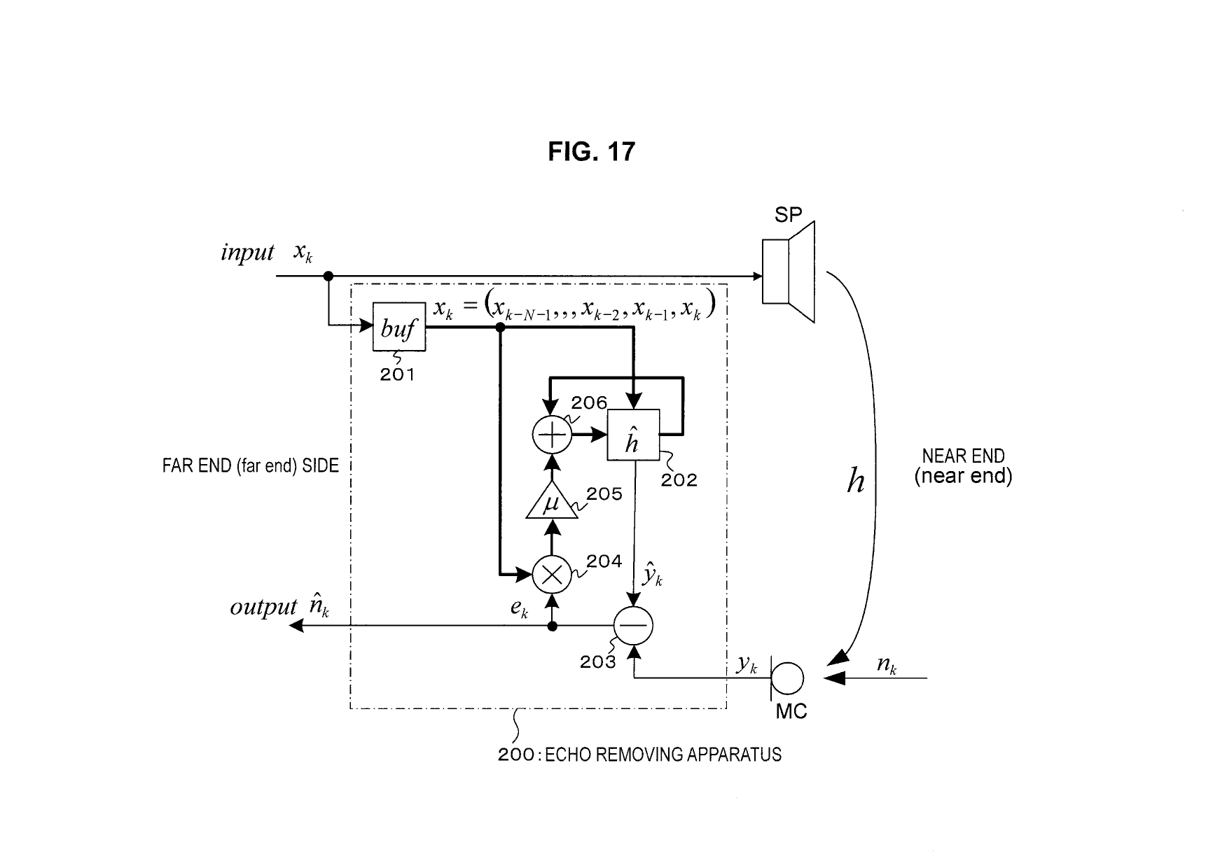

Returning to FIG. 11, after the processing in step ST53, the echo removing apparatus 100A proceeds to processing in step ST54. In step ST54, the echo removing apparatus 100A generates a first error signal e(1)k, a second error signal e(2)k, a third error signal e(3)k, and a fourth error signal e(4)k. The flow chart in FIG. 14 shows details of the processing in step ST54.

The echo removing apparatus 100A starts processing in step ST81 and then proceeds to processing in step ST82. In step ST82, the echo removing apparatus 100A subtracts the first echo estimate y(1)k (hat) from the collected signal (voice signal collected and obtained by the microphone MC) yk to determine the first error signal e(1)k.

Next, in step ST83, the echo removing apparatus 100A subtracts the second echo estimate y(2)k (hat) from the collected signal yk to determine the second error signal e(2)k. In step ST84, the echo removing apparatus 100A subtracts the third echo estimate y(3)k (hat) from the collected signal yk to determine the third error signal e(3)k. Further, in step ST85, the echo removing apparatus 100A subtracts the fourth echo estimate y(4)k (hat) from the collected signal yk to determine the fourth error signal e(4)k. After the processing in step ST85, in step ST86, the echo removing apparatus 100A terminates the processing. Incidentally, the order of processing from step ST82 to step ST85 is not limited to the illustrated order.

Returning to FIG. 11, after the processing in step ST54, the echo removing apparatus 100A proceeds to processing in step ST55. In step ST55, the echo removing apparatus 100A determines an absolute value square (energy) of the collected signal yk and further, of each of the first error signal e(1)k, the second error signal e(2)k, and the third error signal e(3)k and then cumulatively adds these squares.

Next, in step ST56, the echo removing apparatus 100A updates the update section hadapt (hat) (first update section) of the transfer characteristic estimation vector based on the third error signal e(3)k by using the LMS algorithm. Next, in step ST56, the echo removing apparatus 100A updates the update section hspare (hat) (second update section) of the transfer characteristic estimation vector based on the fourth error signal e(4)k by using the LMS algorithm. After the processing in step ST56, the echo removing apparatus 100A proceeds to processing in step ST57.

In step ST57, the echo removing apparatus 100A determines whether k=M holds, that is, whether the fixed period (period of the sample size M) has passed. If k=M does not hold, the echo removing apparatus 100A increments k by 1 in step ST58 before returning to step ST53 to repeat the same processing as described above. On the other hand, if k=M holds, the echo removing apparatus 100A proceeds to processing in step ST59.

In step ST59, the echo removing apparatus 100A determines whether the fixed period immediately before is a disturbance period. The echo removing apparatus 100A makes a determination based on the energy EN1, EN2, EN3, EN4 of the collected signal yk, the first error signal e(1)k, the second error signal e(2)k, and the third error signal e(3)k in the fixed period immediately before respectively (see FIG. 2). The processing in step ST59 is the same as the processing in step ST9 in the flow chart of FIG. 4 described above (see FIG. 8).

Next, after the processing in step ST59, the echo removing apparatus 100A proceeds to processing in step ST60 (see FIG. 12). In step ST60, whether the determination in step ST59 is a disturbance period is judged. If the determination is not a disturbance period, the echo removing apparatus 100A proceeds to processing in step ST61. In step ST61, the echo removing apparatus 100A cumulatively adds the holding section hsusp (hat) of the transfer characteristic estimation vector to the fixed section hfix (hat) of the transfer characteristic estimation vector.

Next, in step ST62, the echo removing apparatus 100A substitutes the update section hadapt (hat) (first update section) of the transfer characteristic estimation vector into the holding section hsusp (hat) of the transfer characteristic estimation vector. Thereafter, in step ST62, the echo removing apparatus 100A clears the update section hadapt (hat) and the update section hspare (hat) (second update section) of the transfer characteristic estimation vector to zero. Then, in step ST63, the echo removing apparatus 100A selects the third error signal e(3)k as the output voice signal nk (hat). After the processing in step ST63, the echo removing apparatus 100A returns to step ST52 to proceed to the processing of the next fixed period as described above.

On the other hand, if the determination is a disturbance period in step ST60, the echo removing apparatus 100A proceeds to processing in step ST64. In step ST64, the echo removing apparatus 100A substitutes the update section hspare (hat) (second update section) of the transfer characteristic estimation vector into the holding section hsusp (hat) of the transfer characteristic estimation vector. Thereafter, in step ST64, the echo removing apparatus 100A clears the update section hspare (hat) and the update section hadapt (hat) (first update section) of the transfer characteristic estimation vector to zero. Then, in step ST65, the echo removing apparatus 100A selects the first error signal e(1)k as the output voice signal nk (hat). After the processing in step ST65, the echo removing apparatus 100A returns to step ST52 to proceed to the processing of the next fixed period as described above.

The echo removing apparatus 100A shown in FIG. 9 substitutes, as described above, the update section hadapt (hat) or the update section hspare (hat) of the transfer characteristic estimation vector (transmission path estimate) as the holding section hsusp (hat) of the transmission path estimate in every fixed period. However, if the fixed period immediately before is determined to be a disturbance period, the holding section hsusp (hat) of the transfer characteristic estimation vector is not cumulatively added to the fixed section hfix (hat) of the transfer characteristic estimation vector. Thus, the fixed section hfix (hat) of the transfer characteristic estimation vector is not disturbed even if there is a disturbance and thus is resistant to disturbance.

If the fixed period immediately before is determined to be a disturbance period, the echo removing apparatus 100A shown in FIG. 9 selects the first error signal e(1)k as the output voice signal. The first error signal e(1)k is obtained by subtracting the first echo estimate y(1)k (hat) determined only by the fixed section hfix (hat) of the transfer characteristic estimation vector from the collected signal yk. Thus, a stable output voice signal nk (hat) whose echo component is canceled can be obtained.

The echo removing apparatus 100A shown in FIG. 9 obtains the third echo estimate y(3)k (hat) by using the input voice signal vector (input voice signal) xk and all transfer characteristic estimation vectors. All transfer characteristic estimation vectors include all fixed sections hfix (hat), holding sections hsusp (hat), and update sections hadapt (hat). Then, the third error signal e(3)k is obtained by subtracting the third echo estimate y(3)k (hat) from the collected signal yk and the update section hadapt (hat) of the transfer characteristic estimation vector is updated based on the third error signal e(3)k. Thus, the transmission path estimation of the fixed section hfix (hat), the holding section hsusp (hat), and the update section hadapt (hat) of the transfer characteristic estimation vector as a whole remains the same and convergence characteristics are not degraded.

If the fixed period immediately before is determined to be a disturbance period, the echo removing apparatus 100A shown in FIG. 9 substitutes the update section hspare (hat) of the transfer characteristic estimation vector into the holding section hsusp (hat) of the transfer characteristic estimation vector. The update section hspare (hat) is updated based on the fourth error signal e(4)k obtained by subtracting the fourth echo estimate y(4)k (hat) from the collected signal yk. Then, the fourth echo estimate y(4)k (hat) is obtained by using the input voice signal xk and the fixed section hfix (hat) and the update section hspare (hat) of the transfer characteristic estimation vector. Thus, an update operation that is not affected by the holding section hsusp (hat) whose transmission path estimate is disturbed by a disturbance can be performed and therefore, transmission path estimation with precision can be continued immediately after the disturbance.

### 3. Modification

In the above embodiments, the evaluation unit 102 determines whether the fixed period immediately before is a disturbance period based on energy of the voice signal yk, the first error signal e(1)k, the second error signal e(2)k, and the third error signal e(3)k in every fixed period. However, the method for the determination by the evaluation unit 102 is not limited to the above example.

When exposed to a disturbance, the transmission path estimate is disturbed and expected to fluctuate significantly with respect to previous periods. Thus, for example, the evaluation unit 102 may determine a change (distance square) of the update section hadapt (hat) of a transfer characteristic estimation vector shown in the following formula (2) to determine whether the fixed period immediately before is a disturbance period.

Δ=|[h_{adapt}]_{k=iM}−[h_{adapt}]_{k=(i-1)M}|² (2)

Also, in the above embodiments, the LMS algorithm is used as an update algorithm of a transfer characteristic estimation vector. However, the update algorithm is not limited to the LMS algorithm and other adaptive algorithms such as the RLS algorithm may naturally be used.

Additionally, the present technology may also be configured as below.

(1) An echo removing apparatus, including:

a transmission path estimate update processing unit; and

an output selection unit,

wherein the transmission path estimate update processing unit divides a transmission path estimate into a fixed section, a holding section, and an update section, updates the update section of the transmission path estimate with an error from an echo estimate determined by using all of the fixed section, the holding section, and the update section of the transmission path estimate, adds the holding section of the transmission path estimate to the fixed section of the transmission path estimate cumulatively and substitutes the update section of the transmission path estimate into the holding section of the transmission path estimate before clearing the update section to zero if it is determined that an estimate obtained by adding the fixed section and the holding section of the transmission path estimate is better than an estimate of the fixed section alone of the transmission path estimate in every fixed period, substitutes the update section of the transmission path estimate into the holding section of the transmission path estimate before clearing the update section to zero if it is determined that the estimate obtained by adding the fixed section and the holding section of the transmission path estimate is not better than the estimate of the fixed section alone of the transmission path estimate in the every fixed period, and

the output selection unit selects the error from the echo estimate determined by using all of the fixed section, the holding section, and the update section of the transmission path estimate as an output voice signal if it is determined that the estimate obtained by adding the fixed section and the holding section of the transmission path estimate is better than the estimate of the fixed section alone of the transmission path estimate in the every fixed period and selects the error from the echo estimate determined by using the fixed section alone of the transmission path estimate as the output voice signal if it is determined that the estimate obtained by adding the fixed section and the holding section of the transmission path estimate is not better than the estimate of the fixed section alone of the transmission path estimate in the every fixed period.

(2) The echo removing apparatus according to (1),

wherein the transmission path estimate update processing unit sets the update section as a first update section and further prepares a second update section separately from the first update section, updates the second update section of the transmission path estimate with the error from the echo estimate determined by using the fixed section and the second update section of the transmission path estimate, adds the holding section of the transmission path estimate to the fixed section of the transmission path estimate cumulatively and substitutes the first update section of the transmission path estimate into the holding section of the transmission path estimate before clearing the first update section and the second update section to zero if it is determined that the estimate obtained by adding the fixed section and the holding section of the transmission path estimate is better than the estimate of the fixed section alone of the transmission path estimate in every fixed period, substitutes the second update section of the transmission path estimate into the holding section of the transmission path estimate before clearing the second update section and the first update section to zero if it is determined that the estimate obtained by adding the fixed section and the holding section of the transmission path estimate is not better than the estimate of the fixed section alone of the transmission path estimate in the every fixed period.

(3) The echo removing apparatus according to (1) or (2), further including:

a determination unit that determines whether the estimate obtained by adding the fixed section and the holding section of the transmission path estimate is better than the estimate of the fixed section alone of the transmission path estimate based on the error of the echo estimate determined by using the fixed section and the holding section of the transmission path estimate and the error of the echo estimate determined by using the fixed section alone of the transmission path estimate in the every fixed period.

(4) The echo removing apparatus according to any one of (1) to (3),

wherein the transmission path estimate update processing unit includes:

a transmission path estimate storage unit that stores the fixed section, the holding section, and the update section of the transmission path estimate;

an echo estimate acquisition unit that acquires a first echo estimate by using an input voice signal and the fixed section of the transmission path estimate and also acquires a third echo estimate by using the input voice signal and all of the fixed section, the holding section, and the update section of the transmission path estimate;

an error signal acquisition unit that acquires a first error signal by subtracting the first echo estimate from a collected signal and also acquires a third error signal by subtracting the third echo estimate from the collected signal;

a first transmission path estimate update unit that updates the update section of the transmission path estimate based on the third error signal; and

a second transmission path estimate update unit that cumulatively adds the holding section of the transmission path estimate to the fixed section of the transmission path estimate and substitutes the update section of the transmission path estimate into the holding section of the transmission path estimate before clearing the update section to zero if the estimate obtained by adding the fixed section and the holding section of the transmission path estimate is better than the estimate of the fixed section alone of the transmission path estimate, and substitutes the update section of the transmission path estimate into the holding section of the transmission path estimate before clearing the update section to zero if the estimate obtained by adding the fixed section and the holding section of the transmission path estimate is not better than the estimate of the fixed section alone of the transmission path estimate, and

the output selection unit selects the third error signal as the output voice signal if the estimate obtained by adding the fixed section and the holding section of the transmission path estimate is better than the estimate of the fixed section alone of the transmission path estimate and selects the first error signal as the output voice signal if the estimate obtained by adding the fixed section and the holding section of the transmission path estimate is not better than the estimate of the fixed section alone of the transmission path estimate.

(5) The echo removing apparatus according to (4),

wherein the transmission path estimate storage unit sets the update section as a first update section and further stores a second update section separately from the first update section,

the echo estimate acquisition unit acquires a fourth echo estimate by using the input voice signal and the fixed section and the second update section of the transmission path estimate,

the error signal acquisition unit acquires a fourth error signal by subtracting the fourth echo estimate from the collected signal and further includes a third transmission path estimate update unit that updates the second update section of the transmission path estimate, and

the second transmission path estimate update unit cumulatively adds the holding section of the transmission path estimate to the fixed section of the transmission path estimate and substitutes the first update section of the transmission path estimate into the holding section of the transmission path estimate before clearing the first update section and the second update section to zero if the estimate obtained by adding the fixed section and the holding section of the transmission path estimate is better than the estimate of the fixed section alone of the transmission path estimate and substitutes the second update section of the transmission path estimate into the holding section of the transmission path estimate before clearing the second update section and the first update section to zero if the estimate obtained by adding the fixed section and the holding section of the transmission path estimate is not better than the estimate of the fixed section alone of the transmission path estimate.

(6) The echo removing apparatus according to (4) or (5),

wherein the echo estimate acquisition unit further acquires a second echo estimate by using the input voice signal and the fixed section and the holding section of the transmission path estimate,

the error signal acquisition unit further acquires a second error signal by subtracting the second echo estimate from the collected signal, further includes an energy acquisition unit that acquires energy EN1 of the collected signal, energy EN2 of the first error signal, energy EN3 of the second error signal, and energy EN4 of the third error signal of the fixed period immediately before in the every fixed period, and further includes a determination unit that determines that the estimate obtained by adding the fixed section and the holding section of the transmission path estimate is better than the estimate of the fixed section alone of the transmission path estimate in the fixed period immediately before if EN2/EN3>1.0, or EN(EN4, EN2, or EN3)/EN1<<1.0 and EN2/EN3>˜1.0.

(7) An echo removing method, including:

a transmission path estimate update processing step; and

an output selection step,

wherein the transmission path estimate update processing step includes:

dividing a transmission path estimate into a fixed section, a holding section, and an update section;

updating the update section of the transmission path estimate with an error from an echo estimate determined by using all of the fixed section, the holding section, and the update section of the transmission path estimate;

adding the holding section of the transmission path estimate to the fixed section of the transmission path estimate cumulatively and substituting the update section of the transmission path estimate into the holding section of the transmission path estimate before clearing the update section to zero if it is determined that an estimate obtained by adding the fixed section and the holding section of the transmission path estimate is better than an estimate of the fixed section alone of the transmission path estimate in every fixed period; and

substituting the update section of the transmission path estimate into the holding section of the transmission path estimate before clearing the update section to zero if it is determined that the estimate obtained by adding the fixed section and the holding section of the transmission path estimate is not better than the estimate of the fixed section alone of the transmission path estimate in the every fixed period, and

the output selection step includes:

selecting the error from the echo estimate determined by using all of the fixed section, the holding section, and the update section of the transmission path estimate as an output voice signal if it is determined that the estimate obtained by adding the fixed section and the holding section of the transmission path estimate is better than the estimate of the fixed section alone of the transmission path estimate in the every fixed period; and

selecting the error from the echo estimate determined by using the fixed section alone of the transmission path estimate as the output voice signal if it is determined that the estimate obtained by adding the fixed section and the holding section of the transmission path estimate is not better than the estimate of the fixed section alone of the transmission path estimate in the every fixed period.

(8) A program for causing a computer to function as a transmission path estimate update processing unit and an output selection unit,

wherein the transmission path estimate update processing unit divides a transmission path estimate into a fixed section, a holding section, and an update section, updates the update section of the transmission path estimate with an error from an echo estimate determined by using all of the fixed section, the holding section, and the update section of the transmission path estimate, adds the holding section of the transmission path estimate to the fixed section of the transmission path estimate cumulatively and substitutes the update section of the transmission path estimate into the holding section of the transmission path estimate before clearing the update section to zero if it is determined that an estimate obtained by adding the fixed section and the holding section of the transmission path estimate is better than an estimate of the fixed section alone of the transmission path estimate in every fixed period, substitutes the update section of the transmission path estimate into the holding section of the transmission path estimate before clearing the update section to zero if it is determined that the estimate obtained by adding the fixed section and the holding section of the transmission path estimate is not better than the estimate of the fixed section alone of the transmission path estimate in the every fixed period, and

the output selection unit selects the error from the echo estimate determined by using all of the fixed section, the holding section, and the update section of the transmission path estimate as an output voice signal if it is determined that the estimate obtained by adding the fixed section and the holding section of the transmission path estimate is better than the estimate of the fixed section alone of the transmission path estimate in the every fixed period and selects the error from the echo estimate determined by using the fixed section alone of the transmission path estimate as the output voice signal if it is determined that the estimate obtained by adding the fixed section and the holding section of the transmission path estimate is not better than the estimate of the fixed section alone of the transmission path estimate in the every fixed period.

(9) A recording medium having recorded therein a program for causing a computer to function as a transmission path estimate update processing unit and an output selection unit,

wherein the transmission path estimate update processing unit divides a transmission path estimate into a fixed section, a holding section, and an update section, updates the update section of the transmission path estimate with an error from an echo estimate determined by using all of the fixed section, the holding section, and the update section of the transmission path estimate, adds the holding section of the transmission path estimate to the fixed section of the transmission path estimate cumulatively and substitutes the update section of the transmission path estimate into the holding section of the transmission path estimate before clearing the update section to zero if it is determined that an estimate obtained by adding the fixed section and the holding section of the transmission path estimate is better than an estimate of the fixed section alone of the transmission path estimate in every fixed period, substitutes the update section of the transmission path estimate into the holding section of the transmission path estimate before clearing the update section to zero if it is determined that the estimate obtained by adding the fixed section and the holding section of the transmission path estimate is not better than the estimate of the fixed section alone of the transmission path estimate in the every fixed period, and

the output selection unit selects the error from the echo estimate determined by using all of the fixed section, the holding section, and the update section of the transmission path estimate as an output voice signal if it is determined that the estimate obtained by adding the fixed section and the holding section of the transmission path estimate is better than the estimate of the fixed section alone of the transmission path estimate in the every fixed period and selects the error from the echo estimate determined by using the fixed section alone of the transmission path estimate as the output voice signal if it is determined that the estimate obtained by adding the fixed section and the holding section of the transmission path estimate is not better than the estimate of the fixed section alone of the transmission path estimate in the every fixed period.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-163936 filed in the Japan Patent Office on Jul. 27, 2011, the entire content of which is hereby incorporated by reference.

What is claimed is:

1. An echo removing apparatus, comprising:
a transmission path estimate update processing unit; and
an output selection unit,
wherein the transmission path estimate update processing unit divides a transmission path estimate into a fixed section, a holding section, and an update section, updates the update section of the transmission path estimate with an error from an echo estimate determined by using all of the fixed section, the holding section, and the update section of the transmission path estimate, adds the holding section of the transmission path estimate to the fixed section of the transmission path estimate cumulatively and substitutes the update section of the transmission path estimate into the holding section of the transmission path estimate before clearing the update section to zero if it is determined that an estimate obtained by adding the fixed section and the holding section of the transmission path estimate is better than an estimate of the fixed section alone of the transmission path estimate in every fixed period, substitutes the update section of the transmission path estimate into the holding section of the transmission path estimate before clearing the update section to zero if it is determined that the estimate obtained by adding the fixed section and the holding section of the transmission path estimate is not better than the estimate of the fixed section alone of the transmission path estimate in the every fixed period, and
the output selection unit selects the error from the echo estimate determined by using all of the fixed section, the holding section, and the update section of the transmission path estimate as an output voice signal if it is determined that the estimate obtained by adding the fixed section and the holding section of the transmission path estimate is better than the estimate of the fixed section alone of the transmission path estimate in the every fixed period and selects the error from the echo estimate determined by using the fixed section alone of the transmission path estimate as the output voice signal if it is determined that the estimate obtained by adding the fixed section and the holding section of the transmission path estimate is not better than the estimate of the fixed section alone of the transmission path estimate in the every fixed period.

2. The echo removing apparatus according to claim 1,
wherein the transmission path estimate update processing unit sets the update section as a first update section and further prepares a second update section separately from the first update section, updates the second update section of the transmission path estimate with the error from the echo estimate determined by using the fixed section and the second update section of the transmission path estimate, adds the holding section of the transmission path estimate to the fixed section of the transmission path estimate cumulatively and substitutes the first update section of the transmission path estimate into the holding section of the transmission path estimate before clearing the first update section and the second update section to zero if it is determined that the estimate obtained by adding the fixed section and the holding section of the transmission path estimate is better than the estimate of the fixed section alone of the transmission path estimate in every fixed period, substitutes the second update section of the transmission path estimate into the holding section of the transmission path estimate before clearing the second update section and the first update section to zero if it is determined that the estimate obtained by adding the fixed section and the holding section of the transmission path estimate is not better than the estimate of the fixed section alone of the transmission path estimate in the every fixed period.

3. The echo removing apparatus according to claim 1, further comprising:
a determination unit that determines whether the estimate obtained by adding the fixed section and the holding section of the transmission path estimate is better than the estimate of the fixed section alone of the transmission path estimate based on the error of the echo estimate determined by using the fixed section and the holding section of the transmission path estimate and the error of the echo estimate determined by using the fixed section alone of the transmission path estimate in the every fixed period.

4. The echo removing apparatus according to claim 1,
wherein the transmission path estimate update processing unit includes:
a transmission path estimate storage unit that stores the fixed section, the holding section, and the update section of the transmission path estimate;
an echo estimate acquisition unit that acquires a first echo estimate by using an input voice signal and the fixed section of the transmission path estimate and also acquires a third echo estimate by using the input voice signal and all of the fixed section, the holding section, and the update section of the transmission path estimate;
an error signal acquisition unit that acquires a first error signal by subtracting the first echo estimate from a collected signal and also acquires a third error signal by subtracting the third echo estimate from the collected signal;
a first transmission path estimate update unit that updates the update section of the transmission path estimate based on the third error signal; and
a second transmission path estimate update unit that cumulatively adds the holding section of the transmission path estimate to the fixed section of the transmission path estimate and substitutes the update section of the transmission path estimate into the holding section of the transmission path estimate before clearing the update section to zero if the estimate obtained by adding the fixed section and the holding section of the transmission path estimate is better than the estimate of the fixed section alone of the transmission path estimate, and substitutes the update section of the transmission path estimate into the holding section of the transmission path estimate before clearing the update section to zero if the estimate obtained by adding the fixed section and the holding section of the transmission path estimate is not better than the estimate of the fixed section alone of the transmission path estimate, and
the output selection unit selects the third error signal as the output voice signal if the estimate obtained by adding the fixed section and the holding section of the transmission path estimate is better than the estimate of the fixed section alone of the transmission path estimate and selects the first error signal as the output voice signal if the estimate obtained by adding the fixed section and the holding section of the transmission path estimate is not better than the estimate of the fixed section alone of the transmission path estimate.

5. The echo removing apparatus according to claim 4,
wherein the transmission path estimate storage unit sets the update section as a first update section and further stores a second update section separately from the first update section,
the echo estimate acquisition unit acquires a fourth echo estimate by using the input voice signal and the fixed section and the second update section of the transmission path estimate,
the error signal acquisition unit acquires a fourth error signal by subtracting the fourth echo estimate from the collected signal and further includes a third transmission path estimate update unit that updates the second update section of the transmission path estimate, and
the second transmission path estimate update unit cumulatively adds the holding section of the transmission path estimate to the fixed section of the transmission path estimate and substitutes the first update section of the transmission path estimate into the holding section of the transmission path estimate before clearing the first update section and the second update section to zero if the estimate obtained by adding the fixed section and the holding section of the transmission path estimate is better than the estimate of the fixed section alone of the transmission path estimate and substitutes the second update section of the transmission path estimate into the holding section of the transmission path estimate before clearing the second update section and the first update section to zero if the estimate obtained by adding the fixed section and the holding section of the transmission path estimate is not better than the estimate of the fixed section alone of the transmission path estimate.

6. The echo removing apparatus according to claim 4,
wherein the echo estimate acquisition unit further acquires a second echo estimate by using the input voice signal and the fixed section and the holding section of the transmission path estimate,
the error signal acquisition unit further acquires a second error signal by subtracting the second echo estimate from the collected signal, further includes an energy acquisition unit that acquires energy EN1 of the collected signal, energy EN2 of the first error signal, energy EN3 of the second error signal, and energy EN4 of the third error signal of the fixed period immediately before in the every fixed period, and further includes a determination unit that determines that the estimate obtained by adding the fixed section and the holding section of the transmission path estimate is better than the estimate of the fixed section alone of the transmission path estimate in the fixed period immediately before if EN2/EN3>1.0, or EN(EN4, EN2, or EN3)/EN1<<1.0 and EN2/EN3>˜1.0.

7. An echo removing method, comprising:
a transmission path estimate update processing step; and
an output selection step,
wherein the transmission path estimate update processing step includes:
dividing a transmission path estimate into a fixed section, a holding section, and an update section;
updating the update section of the transmission path estimate with an error from an echo estimate determined by using all of the fixed section, the holding section, and the update section of the transmission path estimate;
adding the holding section of the transmission path estimate to the fixed section of the transmission path estimate cumulatively and substituting the update section of the transmission path estimate into the holding section of the transmission path estimate before clearing the update section to zero if it is determined that an estimate obtained by adding the fixed section and the holding section of the transmission path estimate is better than an estimate of the fixed section alone of the transmission path estimate in every fixed period; and
substituting the update section of the transmission path estimate into the holding section of the transmission path estimate before clearing the update section to zero if it is determined that the estimate obtained by adding the fixed section and the holding section of the transmission path estimate is not better than the estimate of the fixed section alone of the transmission path estimate in the every fixed period, and
the output selection step includes:
selecting the error from the echo estimate determined by using all of the fixed section, the holding section, and the update section of the transmission path estimate as an output voice signal if it is determined that the estimate obtained by adding the fixed section and the holding section of the transmission path estimate is better than the estimate of the fixed section alone of the transmission path estimate in the every fixed period; and
selecting the error from the echo estimate determined by using the fixed section alone of the transmission path estimate as the output voice signal if it is determined that the estimate obtained by adding the fixed section and the holding section of the transmission path estimate is not better than the estimate of the fixed section alone of the transmission path estimate in the every fixed period.

8. A program for causing a computer to function as a transmission path estimate update processing unit and an output selection unit,
wherein the transmission path estimate update processing unit divides a transmission path estimate into a fixed section, a holding section, and an update section, updates the update section of the transmission path estimate with an error from an echo estimate determined by using all of the fixed section, the holding section, and the update section of the transmission path estimate, adds the holding section of the transmission path estimate to the fixed section of the transmission path estimate cumulatively and substitutes the update section of the transmission path estimate into the holding section of the transmission path estimate before clearing the update section to zero if it is determined that an estimate obtained by adding the fixed section and the holding section of the transmission path estimate is better than an estimate of the fixed section alone of the transmission path estimate in every fixed period, substitutes the update section of the transmission path estimate into the holding section of the transmission path estimate before clearing the update section to zero if it is determined that the estimate obtained by adding the fixed section and the holding section of the transmission path estimate is not better than the estimate of the fixed section alone of the transmission path estimate in the every fixed period, and
the output selection unit selects the error from the echo estimate determined by using all of the fixed section, the holding section, and the update section of the transmission path estimate as an output voice signal if it is determined that the estimate obtained by adding the fixed section and the holding section of the transmission path estimate is better than the estimate of the fixed section alone of the transmission path estimate in the every fixed period and selects the error from the echo estimate determined by using the fixed section alone of the transmission path estimate as the output voice signal if it is determined that the estimate obtained by adding the fixed section and the holding section of the transmission path estimate is not better than the estimate of the fixed section alone of the transmission path estimate in the every fixed period.

9. A recording medium having recorded therein a program for causing a computer to function as a transmission path estimate update processing unit and an output selection unit,
wherein the transmission path estimate update processing unit divides a transmission path estimate into a fixed section, a holding section, and an update section, updates the update section of the transmission path estimate with an error from an echo estimate determined by using all of the fixed section, the holding section, and the update section of the transmission path estimate, adds the holding section of the transmission path estimate to the fixed section of the transmission path estimate cumulatively and substitutes the update section of the transmission path estimate into the holding section of the transmission path estimate before clearing the update section to zero if it is determined that an estimate obtained by adding the fixed section and the holding section of the transmission path estimate is better than an estimate of the fixed section alone of the transmission path estimate in every fixed period, substitutes the update section of the transmission path estimate into the holding section of the transmission path estimate before clearing the update section to zero if it is determined that the estimate obtained by adding the fixed section and the holding section of the transmission path estimate is not better than the estimate of the fixed section alone of the transmission path estimate in the every fixed period, and
the output selection unit selects the error from the echo estimate determined by using all of the fixed section, the holding section, and the update section of the transmission path estimate as an output voice signal if it is determined that the estimate obtained by adding the fixed section and the holding section of the transmission path estimate is better than the estimate of the fixed section alone of the transmission path estimate in the every fixed period and selects the error from the echo estimate determined by using the fixed section alone of the transmission path estimate as the output voice signal if it is determined that the estimate obtained by adding the fixed section and the holding section of the transmission path estimate is not better than the estimate of the fixed section alone of the transmission path estimate in the every fixed period.
